(19) United States
(12) Patent Application Publication
(10) Pub. No.: US 2023/0222452 A1
(43) Pub. Date: Jul. 13, 2023

(54) SYSTEM AND METHOD FOR CUSTOMER CONTACT RANKED SCHEDULING ASSISTANCE

(71) Applicant: RAMD Solutions, Fredericksburg, TX (US)

(72) Inventors: Alissa Davis, Fredericksburg, TX (US); Ryan Muller, Austin, TX (US); Eric Petersen, Austin, TX (US)

(73) Assignee: RAMD Solutions, Fredericksburg, TX (US)

(21) Appl. No.: 17/571,279

(22) Filed: Jan. 7, 2022

(51) Int. Cl. G06Q 10/10; G06Q 10/06

(52) U.S. Cl. CPC G06Q 10/1095; G06Q 10/06316

(57) ABSTRACT

A method of ranking criticality of upcoming customer meetings may comprise receiving, via a network interface device, for a plurality of customers, a meeting deadline date, a meeting frequency value, and a previous sales factor rate indicating revenue or a percentage of previous meetings that resulted in revenue to a user, determining, via a processor, for the plurality of customers, a past due percentage value by dividing the number of days elapsed since the meeting deadline date by a number of days within the meeting frequency value, and determining, for each of the plurality of customers, a criticality ranking by weighting the past due percentage value with the previous sales factor rate. Displaying, via a graphical user interface (GUI), the plurality of customers, listed in order of the criticality ranking, from highest to lowest, for scheduling of upcoming meetings in order of criticality.

### FIELD OF THE DISCLOSURE

The present disclosure generally relates to managing scheduling of customer meetings. More specifically, the present disclosure relates to automatically setting a frequency and order for customer meetings based on a revenue-based criticality ranking for each customer.

### BACKGROUND

The demands on business professionals for efficient time usage have increased precipitously since the advent of computer technology. Electronic calendaring applications allow such professionals to organize and plan out the ways in which such professionals will spend their time throughout a work week, month, year, or on a daily basis. Such applications store, display, alert, and remind professionals about upcoming meetings, such as meetings with clients.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating a customer contact ranked scheduling assistance system for optimal meeting scheduling according to an embodiment of the present disclosure;

FIG. 2 is a graphical illustration depicting a frequency of a graphical user interface (GUI) according to an embodiment of the present disclosure;

FIG. 3A is a graphical illustration depicting a customize window of a GUI for customizing a frequency window according to an embodiment of the present disclosure;

FIG. 3B is a graphical illustration depicting a customize window of a GUI for customizing a queue window according to an embodiment of the present disclosure;

FIG. 4 is a graphical illustration depicting a frequency window of a GUI, including factors critical to determining optimal meeting frequency according to an embodiment of the present disclosure;

FIG. 5A is a graphical illustration depicting a queue window of a GUI for scheduling upcoming customer meetings according to an embodiment of the present disclosure;

FIG. 5B is a graphical illustration depicting a queue window of a GUI for scheduling a ranked list of upcoming customer meetings according to an embodiment of the present disclosure;

FIG. 5C is a graphical illustration depicting a form e-mail for scheduling a future meeting with a customer or account advisor according to an embodiment of the present disclosure;

FIG. 6A is a graphical illustration depicting a daily information window of a GUI for listing customer meetings scheduled for a given date according to an embodiment of the present disclosure;

FIG. 6B is a graphical illustration depicting a customer contact information window of a GUI according to an embodiment of the present disclosure;

FIG. 7 is a flow diagram illustrating a method of defining criticality factors for use in ranking customers according to an embodiment of the present disclosure;

FIG. 8 is a flow diagram illustrating a method of determining criticality factor values for each of a plurality of customers according to an embodiment of the present disclosure;

FIG. 9 is a flow diagram illustrating a method of generating a list, ranked according to urgency, of customers with whom a user needs to schedule upcoming meetings according to an embodiment of the present disclosure.

FIG. 10 is a flow diagram illustrating a method of displaying mapping, location, and customer or account information providing context for the importance of upcoming meetings according to an embodiment of the present disclosure; and

FIG. 11 is a block diagram illustrating a computing system according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

One of the most difficult challenges for salespersons or other professionals needing to routinely meet with customers, clients, or patients in order to maintain a healthy business involves scheduling such meetings in order to maintain those professional relationships. For example, salespersons within the financial services industry may meet with several customers or clients on a daily basis and maintain accounts with hundreds of such individuals. Many professionals meet with customers, clients, or patients that are located over a widespread geographic area, and those meetings may occur at different frequencies. This makes it difficult to develop a repeatable pattern of meetings likely to maintain all of these professional relationships. For example, some customers, clients, or patients may be located in a nearby state to which the professional frequently travels, but the professional may not be capable of scheduling, or need to schedule each of these customers, clients, or patients for meetings in the same time period. This may cause the professional to fail to properly maintain some of these professional relationships by meeting too infrequently, use their time inefficiently by meeting too frequently, or to travel unnecessarily (e.g., to meet with one remote client, customer, or patient one week, then meet with a second remote client, customer, or patient in the same area the next week).

In addition to complexities attributable to diverse locations and meeting frequency needs across a group of clients, customers, or patients, these professionals must also consider other factors critical to prioritizing these meetings in order to optimize the professional's business opportunities or profits. For example, prioritizing meetings with clients, customers, or patients with more critical or time-sensitive needs, or prioritizing meetings with clients, customers, or patients who have an established history of completing larger transactions with the professional may increase revenues or profits, or increase customer service rating approvals for the professional. These are only a few examples of factors the professional may consider as critical for determining priority of customer, client, or patient meetings. Other examples may include inventory needs that fluctuate throughout the year, frequency with which a customer, client, or patient provides customer service ratings (e.g., via Yelp®), patient diagnosis (e.g., routine checkup vs. COVID 19 diagnosis), or the industry in which the customer, client or patient operates. A system is needed to assist professionals in prioritizing and automating scheduling of meetings with such customers, clients, or patients in order to optimize the professionals' revenues or profits derived from such meetings.

The customer contact ranked scheduling assistance system of the present application addresses these issues by suggesting meeting dates with customers, clients, or patients, given in a prioritized order, based on customer, client, or patient information retrieved from information management platforms, such as customer relations management (CRM) platforms. In addition, the customer contact ranked scheduling assistance system may group meetings according to geographic zones in order to decrease unnecessary travel. For example, the customer contact ranked scheduling assistance system in embodiments described herein may retrieve client or customer information routinely stored by uses of the customer contact ranked scheduling assistance system within a customer relations management (CRM) platform, and determine, based on this information, a percentage of the user's total revenues that may be attributable to sales made to each of a plurality of the user's customers. The user may set a frequency of meetings with each of this plurality of customers via a graphical user interface (GUI) of the customer contact ranked scheduling assistance system in various embodiments described herein. The customer contact ranked scheduling assistance system may determine a date upon which the user most recently met with each of the plurality of customers by retrieving such information from either the user's CRM platform, or the user's electronic calendaring platform, for example. A deadline for a next meeting with each of the plurality of customers may then be set by the customer contact ranked scheduling assistance system in various embodiments by adding the number of days in the meeting frequency set by the user for each of the plurality of customers to the date upon which the user last met with each of those customers.

The customer contact ranked scheduling assistance system in embodiments may then provide a list of customers with whom the user needs to set upcoming meetings, ranked according to likelihood such customer may generate revenue for the user. Such a method may begin in various embodiments by identifying a group of customers with whom the user needs to set upcoming meetings, based on the frequency with which the user wishes to meet with each customer. For example, upon determining deadlines for setting meetings with the plurality of customers based on the user-specified meeting frequency, the customer contact ranked scheduling assistance system in embodiments described herein may determine a past due value for each of the plurality of customers by determining the number of days that have elapsed since the deadlines for each of those customers. The customer contact ranked scheduling assistance system may further gauge urgency for each upcoming meeting by dividing the past due value for each of the customers by the user-defined meeting frequency value for each such customer, to determine a past due percentage value. In order to account for the likelihood that customer meetings will result in revenues for the user, the customer contact ranked scheduling assistance system in embodiments may additionally multiply this past due percentage value for each of the customers by the percentage of the user's revenue that are attributable to each of those customers, yielding a criticality ranking for each of the plurality of customers. The GUI for the customer contact ranked scheduling assistance in various embodiments described herein may display a list of the plurality of customers, ranked according to this criticality ranking, from highest to lowest, in order to prompt the user to set meetings with each of the customers in an order most likely to maximize revenues and maintain healthy business relationships across an entire customer base.

The customer contact ranked scheduling assistance system in embodiments may further minimize unnecessary travel by grouping meetings according to customer location in embodiments described herein. For example, when a user establishes an upcoming meeting with a first customer in a given geographic area, location, city, state, or zone, the customer contact ranked scheduling assistance system may identify a second customer listed next within the list of customers ranked according to criticality ranking described directly above that is also located within the same geographic area, location, city, state, or zone. The customer contact ranked scheduling assistance system in embodiments may then prompt the user to set a meeting with this second customer on the same day or week as the appointment with the first customer. In such a way, the customer contact ranked scheduling assistance system in an embodiment may direct the user to schedule meetings according to an urgency defined by each customer's revenue and the user's success rate at making sales to such customers, and to group those meetings geographically in order to minimize travel time.

In various other embodiments described herein, users may direct the customer contact ranked scheduling assistance system to rank customers according to criticality factors other than the percentage of the user's revenues that may be attributable to each customer. For example, the customer contact ranked scheduling assistance system may determine a previous success rate for each of the plurality of customers by dividing the total number of previous meetings with each customer by the number of meetings that resulted in sales to that customer. This previous success rate may be used as the criticality factor for ranking the urgency of future meetings by multiplying the past due percentage value for each of the plurality of customers by this previous success rate in some embodiments. In other embodiments, the user may specify other criticality factors by selecting any type of customer information stored at the CRM platform. For example, a user may identify customer industry, account age, fluctuating inventory needs for each customer, the customer's average revenue or size, or average online review scoring as a criticality factor for ranking the urgency of upcoming customer meetings.

In some embodiments described herein, the customer contact ranked scheduling assistance system may specify combinations of criticality factors. For example, the customer contact ranked scheduling assistance system may determine the rank for a plurality of customers with whom meetings need to be set by taking into account both the percentage of the user's revenue attributable to each customers and the previous success rate for each of the customers. The customer contact ranked scheduling assistance system in embodiments may do so by adding the revenue percentage value and the previous success rate percentage for each of the plurality of customers, to generate a combined criticality factor value for each of the plurality of customers. The customer contact ranked scheduling assistance system in such embodiments may then determine a criticality ranking for each of the customers by multiplying the past due value for each of the customers by the combined criticality factor value for each of the customers.

Although the user may wish to consider multiple criticality factors (e.g., revenue and success rate) when determining urgency of upcoming meetings, the user may not consider these factors to be equally important. Thus, when ranking urgency of upcoming meetings according to a plurality of criticality factors in such a way, the customer contact ranked scheduling assistance system may allow the user to assign weights to each of these criticality factors. For example, the user may assign, using the GUI, a first weight (e.g., 0.5) to consideration of the revenue percentage value for each of the customers, and assign a second weight (e.g., 0.2) to consideration of the previous success rate for each of the customers. The customer contact ranked scheduling assistance system may then determine a weighted criticality factor value for each customer, for each of the criticality factors. For example, the customer contact ranked scheduling assistance system may determine a weighted revenue percentage value by multiplying the revenue percentage value for each of the customers by the first weight (e.g., 0.5). The customer contact ranked scheduling assistance may also determine a weighted previous success rate value by multiplying the previous success rate percentage value for each of the customers by the second weight (e.g., 0.2). A weighted and combined criticality factor value may then be determined by adding the weighted revenue percentage value and the weighted previous success rate. The customer contact ranked scheduling assistance system in such embodiments may then determine a weighted criticality ranking for each of the customers by multiplying the past due value for each of the customers by the weighted and combined criticality factor value for each of the customers. In such a way, the user may indicate the relative importance of each of the criticality factors in determining urgency of upcoming meetings.

The customer contact ranked scheduling assistance system in embodiments described herein may assist the user in scheduling meetings with a plurality of customers, in the ranked order displayed via the GUI, in order to most likely maximize revenues and maintain healthy business relationships across an entire customer base. For example, the user may select a date and time to meet with the highest ranked customer in the ranked list, and the customer contact ranked scheduling assistance system may auto-populate a draft e-mail to the user-selected customer, inviting her to attend a meeting on the user-specified date. Once a plurality of customer meetings have been scheduled, he customer contact ranked scheduling assistance system in embodiments described herein may further display a high-level summary of meetings set for a given day, with particular emphasis on customer information used to determine the urgency of such meetings. For example, the customer contact ranked scheduling assistance system may display a list of customers with whom a user has scheduled meetings for a given day, along with the percentage of the user's revenue attributable to each such customer, and the previous success rate of meetings with each such customer. In such a way, the customer contact ranked scheduling assistance system and the GUI may provide the user with a snapshot or summary of information describing why each of the meetings that are set to occur on that date are urgent, critical, or important to the user, as well as a map of each of the locations where the meetings are scheduled to occur.

The customer contact ranked scheduling assistance system may also view a list of appointments for a user-specified date via the “today” window within the GUI. For example, the user may select a date for display, and the customer contact ranked scheduling assistance system may retrieve all appointments for the user-specified date from the user's electronic calendar platform. The customer contact ranked scheduling assistance system may further communicate with the user's CRM platform or other information management platform to retrieve customer, client, or patient information associated with the contact name identified within the retrieved calendar appointments. For example, the customer contact ranked scheduling assistance system may retrieve the account associated with the named contact, the address, phone, appointment start time, or other information (e.g., meeting frequency, percentage of annual revenue, assistant's contact information) from the CRM platform. In embodiments, the customer contact ranked scheduling assistance system may also communicate with a mapping platform to generate a map showing each of the retrieved addresses for the meetings set to occur on the user-specified date. The customer contact ranked scheduling assistance system may then display this information via the GUI, to provide the user with a snapshot or summary of information about each of the meetings that are set to occur on the user-specified date, as well as a map of each of the locations where the meetings are scheduled to occur.

A user may seek more in-depth information about a given meeting in embodiments of the present disclosure by selecting one of the listed meetings scheduled for the user-selected date. For example, upon selecting or clicking on one of the listed meetings, the customer contact ranked scheduling assistance system may display all information retrieved from the CRM platform or other information management platform, including total revenue attributable to that contact, date of last visit, contact information for an assistant, or any other information stored by the user and associated with that account at the CRM platform or other information management platform. The customer contact ranked scheduling assistance system in embodiments may also communicate with the mapping platform to retrieve a more detailed or localized map for that specific meeting, and display this more detailed map with the detailed information for the named contact or account. In such a way, the customer contact ranked scheduling assistance system may gather, organize, and display information drawn from several disparate platforms (e.g., user's electronic calendar, mapping platform, user's CRM platform) upon the user's request (e.g., selection of a given date via the GUI) to provide varying levels of information about the user's upcoming meetings. This information may be retrieved from these disparate platforms each time the user selects a new date to view, and may not be stored permanently at the customer contact ranked scheduling assistance system or at the computing system executing the customer contact ranked scheduling assistance system. By retrieving this information via the disparate platform APIs upon each user request, the customer contact ranked scheduling assistance system avoids duplicate storage of customer, client, or patient information across multiple platforms, which may present inefficiencies, unnecessary costs, and unnecessary potential for security breaches with respect to potentially confidential information.

Further, the customer contact ranked scheduling assistance system allows managers to guide less experienced employees in prioritizing customer, client, or patient meetings. For example, in some embodiments described herein, permission to select the factor deemed critical to the determination of meeting priority may be limited to specific users, such as managers or executives. The customer contact ranked scheduling assistance system in such embodiments may display this manager-selected information (e.g., revenue) for each customer, client, or patient on the “frequency” window of the GUI, as viewed by several less experienced or lower-level employees when determining an optimal frequency with which to schedule meetings for these accounts. In other embodiments, the customer contact ranked scheduling assistance system may also rank upcoming meetings for such a less experienced employee according to the factors identified by the manager or more experienced employee as critical to the determination of meeting priority. When identifying these factors via the GUI, the manager may further identify a weight to be assigned to this factor for determining the rank or urgency of each customer meeting, and the customer contact ranked scheduling assistance system may then list several potential upcoming meetings for the less experienced employee, ranked according to this manager-assigned weight. In such a way, the customer contact ranked scheduling assistance system may provide an order guided by a manager or more experienced employee in which the less experienced employee should schedule upcoming meetings with customers, clients, or patients in order to optimize the organization's business performance.

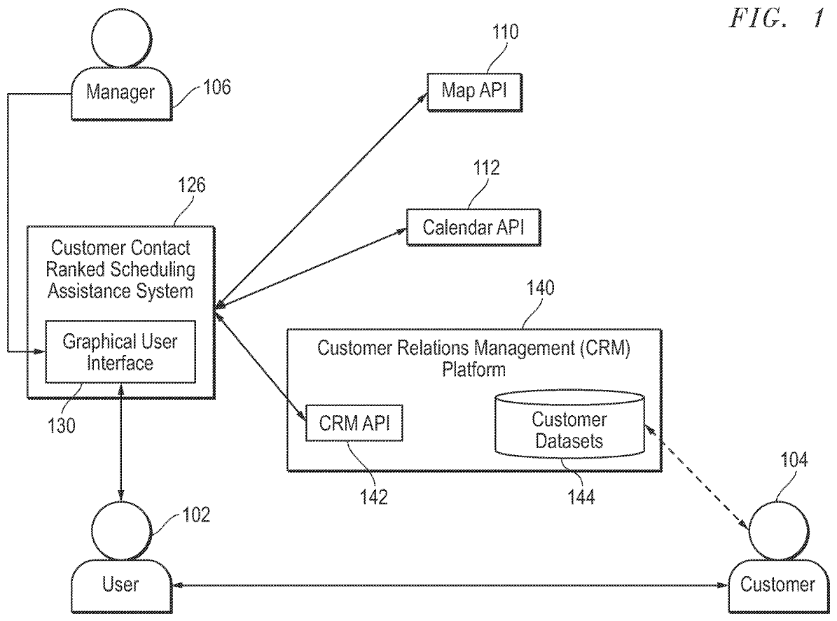

FIG. 1 is a block diagram illustrating a customer contact ranked scheduling assistance system 126 retrieving customer, client, or patient information via various application programming interfaces (APIs) for scheduling of meetings to optimize a user's business performance according to an embodiment of the present disclosure. As described herein, one of the most difficult challenges for salespersons or other professionals (e.g., user 102) needing to routinely meet with customers, clients, or patients 104 in order to maintain a healthy business involves scheduling such meetings in order to maintain those professional relationships. User 102 may meet with customer 104 and other customers, clients, or patients that are located over a widespread geographic area, and those meetings may occur at different frequencies, making it difficult to develop a repeatable pattern of meetings likely to maintain all of these professional relationships. In addition, user 102 may also consider other factors critical to prioritizing these meetings in order to optimize the user's 102 business opportunities or profits. The customer contact ranked scheduling assistance system 126 in an embodiment addresses these issues by suggesting to user 102 meeting dates with customer 104, and other customers, clients, or patients, given in a prioritized order, based on customer, client, or patient information retrieved from information management platforms, such as customer relations management (CRM) platform 140.

The present disclosure refers repeatedly to “customers” of “salespersons.” However, use by a salesperson to schedule meetings with customers is only one example of an application of the customer contact ranked scheduling assistance system. The present disclosure further contemplates that the user of the customer contact ranked scheduling assistance system may include any individual whose business is impacted by maintenance of relationships through frequent or repeating meetings (e.g., in-person or remote). For example, a user of the customer contact ranked scheduling assistance system may include a health care professional checking in or performing home visits (or tele-visits) with patients, accounting or legal professionals developing their businesses by adding clients, or vendors or distributors attempting to increase the scope of their trading area. Further, the present disclosure repeatedly refers to CRM platforms, but various embodiments contemplate any type of information management platform used to maintain information about customers, clients, or patients routinely used during the user's course of business. The customer contact ranked scheduling assistance system of the present disclosure may be used by any of these individuals, and may tailor the prioritization of such meetings to specific factors that are critical for each users' industry, profession, or goals.

The customer contact ranked scheduling assistance system described herein may connect with various cloud-based information management platforms via application programming interfaces (APIs) to gather information about users' customers, clients, or patients that the users may depend upon to prioritize meetings. For example, the customer contact ranked scheduling assistance system 126 in an embodiment may gather customer information such as contact information, location, industry, previous sales, and previous revenues from a customer relations management (CRM) platform 140 maintained by the user, via an API 142. Many users of the customer contact ranked scheduling assistance system may use these CRM platforms (e.g., 140), such as SalesForce®, for example, to track information about their customers and to assist with customer communication. These CRM platforms (e.g., 140) (or other information management platforms) store, sort, and transmit datasets containing such customer information easily with other programs or applications (e.g., the customer contact ranked scheduling assistance system 126) via APIs (e.g., 142), but do not assist with prioritization of meetings with these customers. In other embodiments, customer, client, or patient information accessed by the customer contact ranked scheduling assistance system 126 may be stored in other types of platforms or databases, including online review filter platforms (e.g., Vivial®), or various medical patient portals, for example. Since these CRM platforms (e.g., 140) or other customer, client, or patient portals, information management platforms, or databases often store information users find most important or pertinent to the performance of their businesses with respect to each customer (e.g., 104), client, or patient, these information management platforms are likely to store at least one type of information about each customer (e.g., 104), client, or patient that may be useful to consider when prioritizing meetings with customers (e.g., 104), clients, or patients. For example, many CRM platforms (e.g., 140) store previous sales information for customers (e.g., 104), including total revenue, online review filter platforms may store a measure of a given customers, clients, or patients positive or negative reviews, and patient portals store diagnosis codes indicating an urgency or critical need for frequent medical care visits.

The customer contact ranked scheduling assistance system 126 in an embodiment may connect with various information management platforms (e.g., CRM 140) via application programming interfaces (APIs) (e.g., CRM API 142) to gather information about users' customers, clients, or patients that the user 102 may depend upon to prioritize meetings. For example, the customer contact ranked scheduling assistance system 126 in an embodiment may request and receive, via the CRM API 142 information about customer 104, such as contact information, location, industry, revenue percentage values, or previous success rates. CRM 140 may store such information within customer datasets 144, as managed and controlled by the user 102, or the user's organization.

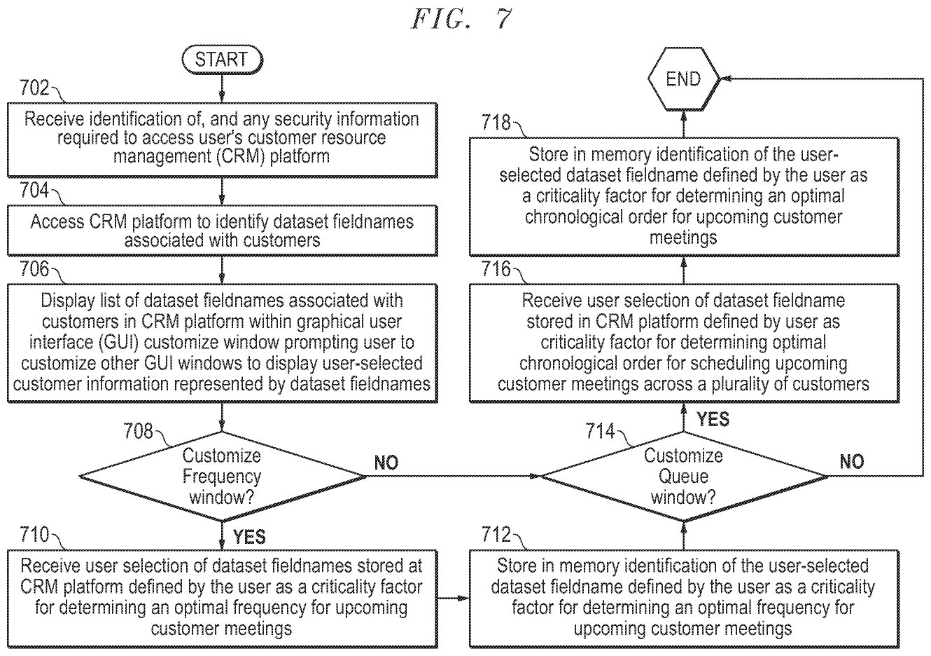

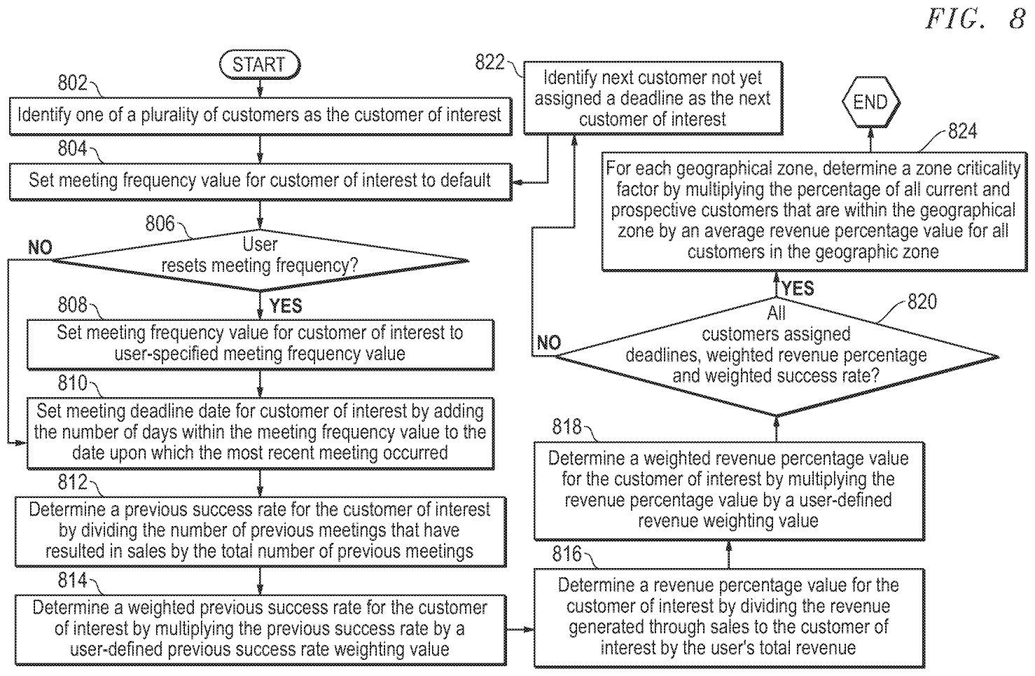

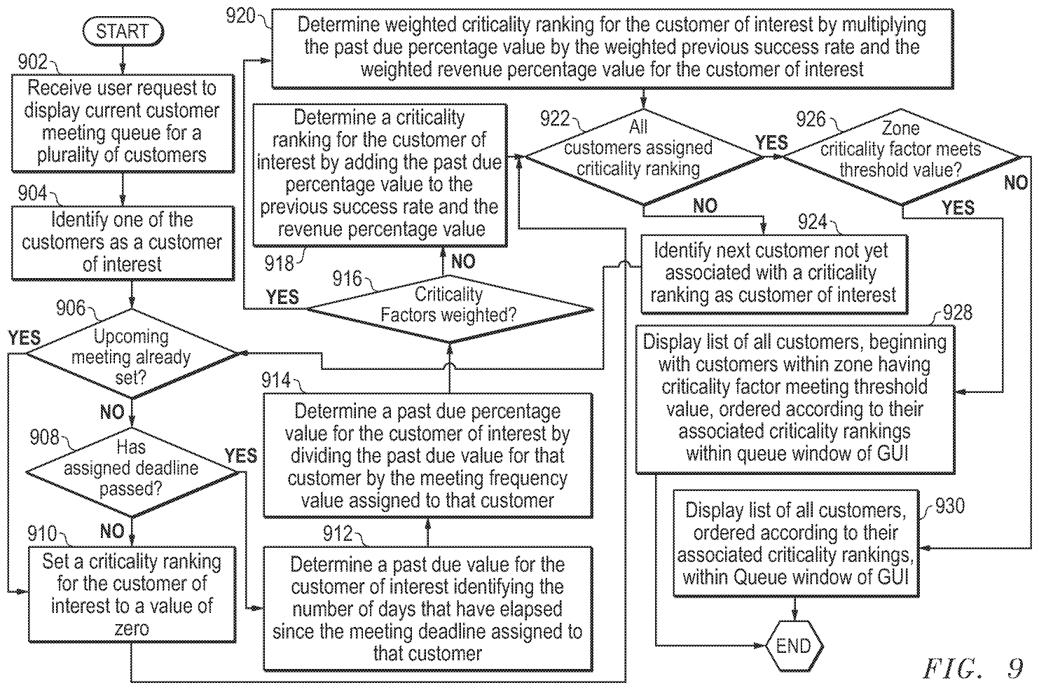

User 102 or her organization may store information about customer 104 that the user 102 or her organization finds most important or pertinent to the performance of their business. Thus, CRM platform 140 may store at least one type of information about customer 104 that may be useful to consider when prioritizing meetings with customer 104 and other customers, clients, or patients. For example, CRM platform 140 store previous sales information for customer 104, including total revenue, or the percentage of the user's 102 annual revenue that is attributable to customer 104 (e.g., revenue percentage value). In some embodiments, the customer contact ranked scheduling assistance system may retrieve these datasets (e.g., datasets containing revenue percentage value, weighted revenue percentage value, previous success rate, or weighted previous success rate) from the CRM platform 140 in order to determine a criticality ranking for each of the customers defining the urgency of setting an upcoming meeting with these customers in order to maximize the user's revenues, as described in greater detail below with respect to FIGS. 8 and 9. In other embodiments, the user 102 may select other datasets (e.g., datasets containing age of the account) for the customer contact ranked scheduling assistance system to use in determining the criticality ranking, as described in greater detail below with respect to FIG. 7.

The customer contact ranked scheduling assistance system in an embodiment may gather from user 102 credentials needed to access information about customer 104 through the CRM API 142, via a graphical user interface (GUI) 130. A list of the types of information stored at CRM 140 may then be retrieved by the customer contact ranked scheduling assistance system 126. For example, the customer contact ranked scheduling assistance system 126 in embodiments may retrieve a list of all data types stored at the customer datasets 144 of CRM 140, including name, position, account number, employer/business, industry, phone, address, previous success rates, and prior sales revenues attributable to customer 104 or other customers, clients, or patients. This information may be stored at the CRM platform 140 or other information management platform in the form of datasets, with each dataset containing a dataset fieldname (e.g., “address”) and a dataset field value (e.g., “789_Bayou_dr”).

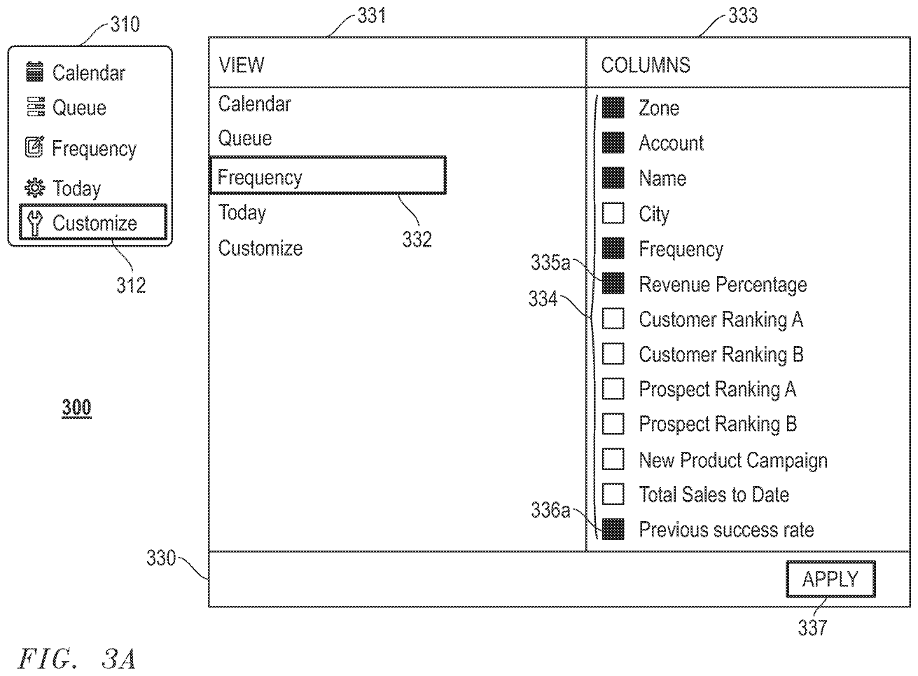

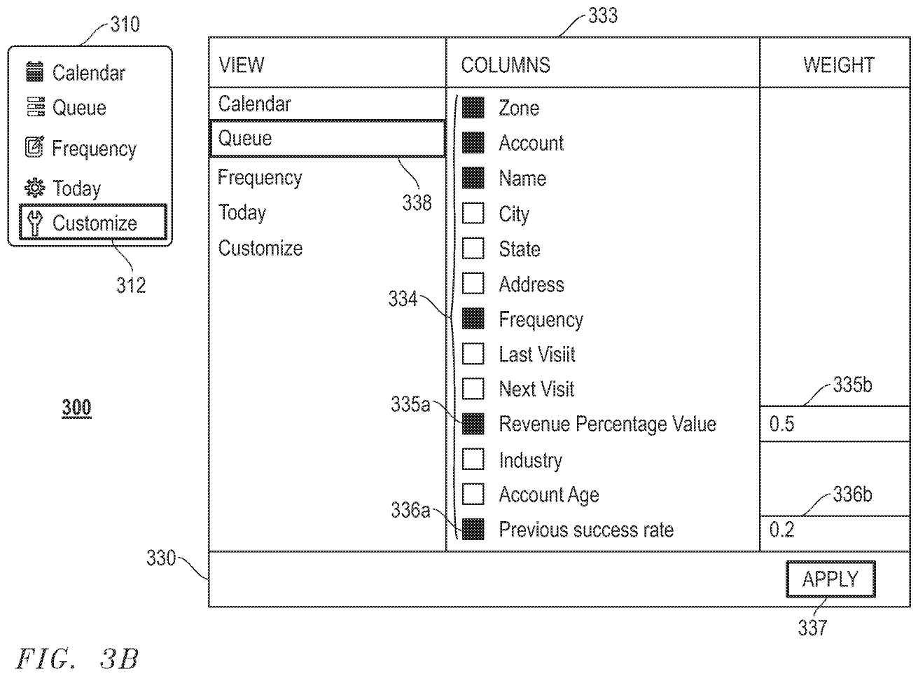

The customer contact ranked scheduling assistance system 126 in an embodiment may retrieve each of the dataset fieldnames describing customer datasets 144 (e.g., for customer 104 and other customers, clients, or patients) stored at the CRM platform 140 and display these dataset 144 fieldnames or descriptions thereof via the GUI 130 for selection by the user 102 as a criticality factor for determining an optimal chronological order or an optimal frequency for upcoming customer meetings, as described in greater detail with respect to FIGS. 3A and 3B. For example, the customer contact ranked scheduling assistance system 126 may display a list of dataset 144 fieldnames retrieved from CRM platform 140 via the GUI 130, including name, position, account number, employer/business, industry, phone, address, previous success rate, and revenue percentage values or percentage of user 102's revenues attributable to customer 104, frequency of sales, or cyclical purchasing information indication an inclination for a given customer to make purchases at particular points throughout a year. In such an example, the user 102 may select, via the GUI 130, percentage of user 102's revenues attributable to customer 104 as a criticality factor for determining an optimal chronological order or an optimal frequency for upcoming customer meetings. As described herein, the customer contact ranked scheduling assistance system 126 in an embodiment may then display a dataset from within customer datasets 144 associated with customer 104 and having the dataset fieldname selected by the user 102 as critical to determining an optimal chronological order or an optimal frequency for upcoming customer meetings. For example, the customer contact ranked scheduling assistance system 126 may display the user's 102 revenues attributable to customer 104, to assist user 102 in determining an optimal frequency with which to schedule meetings with customer 104. In some embodiments, the customer contact ranked scheduling assistance system 126 may further use this factor (e.g., revenue attributable to customer 104) to rank the importance of scheduling an upcoming meeting with customer 104 in comparison to importance of scheduling upcoming meetings with other customers, clients, or patients. Because the customer contact ranked scheduling assistance system 126 may determine such a customer ranking based on the date of the last meeting with each customer and whether an upcoming meeting has already been scheduled with each customer, the system 126 may dynamically change the rankings of customers based on impromptu meetings or other changes.

The user 102 may select one or more accounts for scheduling from a queue of future meetings displayed via the GUI 130, and the customer contact ranked scheduling assistance system 126 may generate a form e-mail to the named contact (e.g., customer 104) for that account, based on a user-provided start time, end time, and date, input via the GUI 130. The customer contact ranked scheduling assistance system 126 may then transmit a request to the user's 102 calendar API 112 (or user's 102 e-mail platform API if operated separately from electronic calendar API) to forward the form e-mail to the customer 104. The customer contact ranked scheduling assistance system 126 in an embodiment may also transmit a request to calendar API 112 to store a calendar appointment with the customer 104 on the user-defined date, at the user-defined start time. In some embodiments, storage of such an appointment at the user's electronic calendar 112 may occur after the customer 104 accepts the e-mail invitation to such an appointment. In some embodiments, the calendar appointment may also be stored at the electronic calendar for a manager 106 of the user 102, allowing such a manager 106 to easily view the user's 102 (e.g., salesperson) activities for the day.

The customer contact ranked scheduling assistance system 126 may also communicate with a map API 110 and the calendar API 112 in order to gather information for displaying a list of appointments for a user 102 specified date within the GUI 130. For example, the user 102 may select a date for display, and the customer contact ranked scheduling assistance system 126 may retrieve all appointments for the user-specified date from the user's 102 electronic calendar platform via calendar API 112. The customer contact ranked scheduling assistance system 126 may further communicate with the user's CRM platform 140 to retrieve customer datasets 144 associated with the contact name (e.g., customer 104) identified within the retrieved calendar appointments. For example, the customer contact ranked scheduling assistance system 126 may retrieve the account associated with customer 104, the address, phone, appointment start time, or other information (e.g., meeting frequency, revenue percentage value, previous success rate, frequency of sales, or cyclical purchasing information, assistant's contact information) from the CRM platform 140. In an embodiment, the customer contact ranked scheduling assistance system 126 may also communicate with a mapping platform via map API 110 to generate a map showing each of the retrieved addresses for the meetings set to occur on the user 102 specified date, including a meeting with customer 104. The customer contact ranked scheduling assistance system 126 may then display this information via the GUI 130, to provide the user 102 with a snapshot or summary of information about each of the meetings that are set to occur on the user 102 specified date, including a meeting with customer 104, as well as a map of each of the locations where the meetings are scheduled to occur. In an embodiment in which user 102 seeks more in-depth information about a given meeting (e.g., with customer 104) by selecting the listed meeting with customer 104 scheduled for the user 102 selected date, the customer contact ranked scheduling assistance system 126 may also communicate with the mapping platform via map API 110 to retrieve a more detailed map of customer 104's location.

In such a way, the customer contact ranked scheduling assistance system 126 may gather, organize, and display customer datasets 144 drawn from several disparate platforms (e.g., CRM 140, a mapping platform accessible via map API 110, and the user's 102 electronic calendar accessible via calendar API 112) upon the user's 102 request (e.g., selection of a given date via the GUI 130) to provide varying levels of information about the user's 102 upcoming meeting with customer 104. This information may be retrieved from these disparate platforms each time the user 102 selects a new date to view, and may not be stored permanently at the customer contact ranked scheduling assistance system 126 or at the computing system executing the customer contact ranked scheduling assistance system 126. By retrieving this information via the disparate platform APIs (e.g., 110, 112, 142) upon each user 102 request, the customer contact ranked scheduling assistance system 126 avoids duplicate storage of customer datasets 144 across multiple platforms, which may present inefficiencies, unnecessary costs, and unnecessary potential for security breaches with respect to potentially confidential information.

The customer contact ranked scheduling assistance system in an embodiment may also receive information from a manager 106 of the user 102 via the GUI 130. As described herein, the customer contact ranked scheduling assistance system 126 in an embodiment may allow manager 106 to guide less experienced employees such as user 102 in prioritizing customer, client, or patient meetings. For example, permission to select a factor deemed critical to determining an optimal chronological order or an optimal frequency for upcoming customer meetings via GUI 130 may be limited to specific users, such as manager 106 or other more experienced employees, higher-level employees, or executives. The customer contact ranked scheduling assistance system 126 in such embodiments may display this manager 106 selected information (e.g., revenue percentage value or previous success rate, frequency of sales, or cyclical purchasing information) for each customer, client, or patient via GUI 130 to assist several less experienced or lower-level employees, including user 102, in determining an optimal frequency with which to schedule meetings for these accounts, or to prioritize upcoming meetings within their queues. In such a way, the customer contact ranked scheduling assistance system 126 may provide an order guided by a manager 106 or more experienced employee in which the less experienced employee such as user 102 should schedule upcoming meetings with customers, clients, or patients in order to optimize the organization's business performance.

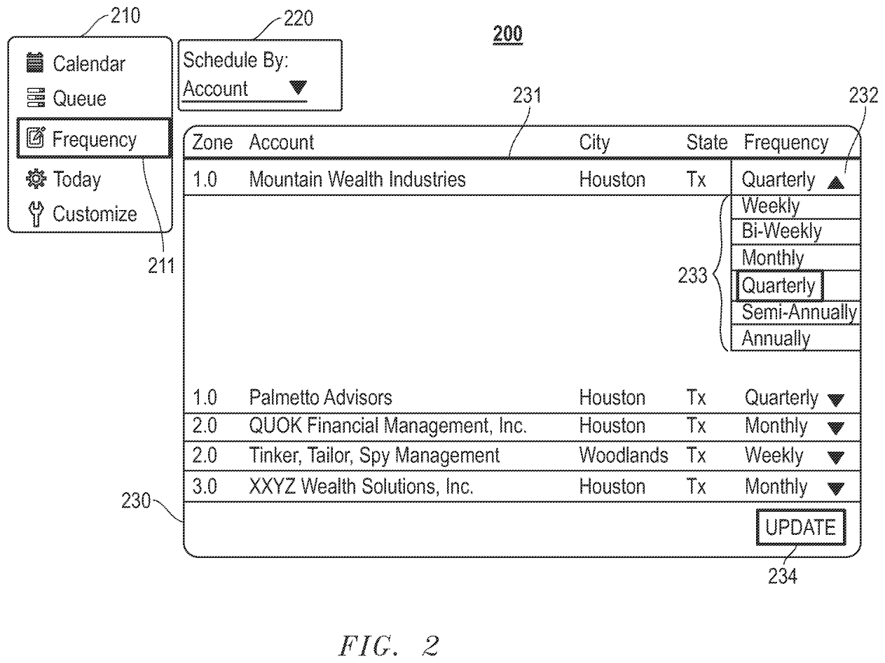

FIG. 2 is a graphical illustration depicting a frequency window of a graphical user interface (GUI) for selecting a meeting frequency for multiple accounts or customers according to an embodiment of the present disclosure. This meeting frequency value in an embodiment may be used to rank customer meetings according to urgency determined based on likelihood such meetings may generate revenue for the user in an embodiment, as described in greater detail with respect to FIG. 9, below. The user of the customer contact ranked scheduling assistance system in various embodiments described herein may view information about a plurality of customers, clients, or patients retrieved from the remote information management platform (e.g., CRM platform), via a GUI 200, in order to determine an optimal frequency with which each customer, client, or patient should be scheduled for a meeting. In other embodiments, a default frequency may be preset for all customers, clients, or patients. For example, meetings with customers may be set to occur weekly, monthly, or quarterly. As another example, meetings with customers may be set to occur at a preset time period following a sale of an item, such as within one week of such a sale. In yet another example, meetings with customers may be set to occur annually.

The GUI 200 in an embodiment may include a page window menu 210, listing a plurality of windows the GUI 200 may be capable of displaying. For example, the page window menu 210 may list a calendar window tab, a queue window tab, a frequency window tab 211, a daily information window tab, and a customize window tab. The calendar window in an embodiment may display information about upcoming meetings between the user and a plurality of customers, given in a calendar format (e.g., by day, week, month, or year). The queue window in an embodiment may list a ranked order of meetings with customers the user needs to schedule, based on a user-defined frequency, or on factors identified by the user or a manager as critical to determining an optimal chronological order or an optimal frequency for upcoming customer meetings. The frequency window in an embodiment may list several accounts or customers, and allow the user to select a frequency with which the user should scheduling meetings for each customer. The daily information window in an embodiment may list a plurality of meetings currently scheduled for a user-specified date, along with various customer information relating to these meetings. The customize window in an embodiment may allow the user or a manager to select one or more dataset fieldnames (e.g., revenue percentage value or previous success rate) as critical for determining an optimal chronological order within the queue window or an optimal frequency for upcoming customer meetings as defined in the frequency window.

Selection by the user of the frequency window menu tab 211 in an embodiment may initiate display via GUI 200 of a frequency window 230, listing several accounts or customers, to allow the user to select a frequency with which the user should scheduling meetings for each customer. The frequency window 230 may display basic customer information identifying each customer, including the name of the customer, or the customer's business or employer (e.g., mountain wealth industries). The user may then select a frequency with which she wishes to schedule meetings with each displayed customer, or account, based on the retrieved and displayed customer information. The sorting menu 220 in an embodiment may allow the user to sort the listed accounts or customers in the frequency window 230 according to a sorting value (e.g., account, advisor, firm, zone, city, state, zip). For example, the sorting value may be chosen by selection within a drop down menu within the sorting menu 220. The GUI 200 may then display several accounts (e.g., account 231 with Mountain Wealth Industries), listed in alphabetical order by account name, or some other order, within the frequency window 230.

The user may provide a user-selected meeting frequency value for a given account or contact via a drop down menu 232 in an embodiment. The drop-down menu 232 in an embodiment may be populated with a plurality of meeting frequency options 233, such as, for example, weekly, bi-weekly, monthly, quarterly, semi-annually, or annually. The user may select the user-selected meeting frequency value (e.g., quarterly) by selecting or clicking on one of these available meeting frequency options 233 within the drop-down menu 232. Upon selecting the user-selected meeting frequency value (e.g., quarterly) in an embodiment, the user may apply this user-selected meeting frequency value to the highlighted account (e.g., mountain wealth industries) by selecting the update button 234 within the frequency window 230.

The customer contact ranked scheduling assistance system in an embodiment may store an association between the highlighted account (e.g., mountain wealth industries), and the user-selected meeting frequency value (e.g., quarterly) upon selection of the update button 234 in an embodiment. In another embodiment, the association between the highlighted account (e.g., mountain wealth industries), and the user-selected meeting frequency value (e.g., quarterly) may be transmitted by the customer contact ranked scheduling assistance system for storage at the user's CRM platform or other information management system. In still other embodiments, a default frequency may be preset for all customers, clients, or patients. For example, meetings with customers may be set to occur weekly, monthly, or quarterly. As another example, meetings with customers may be set to occur at a preset time period following a sale of an item, such as within one week of such a sale. In yet another example, meetings with customers may be set to occur annually.

FIG. 3A is a graphical illustration depicting a customize window of a graphical user interface (GUI) allowing a user to identify factors critical for determining an optimal frequency for upcoming customer meetings according to an embodiment of the present disclosure. As described herein, the customize window in an embodiment may allow the user or a manager to select one or more dataset fieldnames (e.g., revenue percentage value or previous success rate) as critical to determining an optimal frequency for upcoming customer meetings. Selection by the user of the customize window tab 312 in an embodiment may initiate display via GUI 300 of a customize window 330, listing one or more GUI windows 331 that may be customized, including, for example, the calendar window, the queue window, the frequency window, or the daily information window. At 332, the user may select the frequency window in order to customize the information displayed via the GUI (e.g., GUI 200 described above with reference to FIG. 2) within the frequency window (e.g., 230).

The customer contact ranked scheduling assistance system in an embodiment may retrieve one or more dataset fieldnames describing customer information stored at the CRM platform and display these dataset fieldnames or descriptions thereof via the GUI 300 for selection by the user as a criticality factor for determining an optimal frequency for upcoming customer meetings. For example, the customize window 330 may display a list 334 of dataset fieldnames retrieved from a CRM platform via the GUI, including zone, account, name, city, frequency, annual revenue percentage, one or more customer ranking values (e.g., customer ranking A or customer ranking B), one or more prospective customer ranking values (e.g., prospect ranking A, prospect ranking B), specific sales campaigns (e.g., campaign for a specifically identified new product), total sales to date, or previous success rate (e.g., percentage of previous meetings that resulted in purchases or revenues). These are only a few examples of dataset fieldnames or descriptions that may be retrieved from the user's CRM or other information management platform. Other embodiments contemplate retrieval of other types of information dataset fieldnames, including, for example, state, address, last visit, next visit, industry, account age number of previous meetings, customer position, account number, employer/business, industry, prior sales revenues, online review activity metrics (e.g., number of reviews completed), or diagnosis codes.

Current and prospective customer rankings may group current or prospective customers based on a projected likelihood that relationships with such customers will produce sales, or a projected volume or value of such sales. Several strategic retail marketing services currently provide such services to sales teams, such as users of the customer contact ranked scheduling assistance system. Such customer ranking services may rank customers into a plurality of groups, such as group A, group B, group C, and group D, based upon a variety of factors used to distinguish top performing customers from lower performing customers. For example, such factors may represent considerations such as whether the customer is a heavy spender, whether the customer routinely shops only during sales periods, whether the user is currently engaged in a campaign for a specific product the customer has previously purchased, whether the customer has purchased from the user more recently than others. Other factors considered may include, for example, the regularity of purchases made by each customer, the depth and type of products purchased, and receptiveness to previous offers and communications. These and other factors may be used to rank or group customers by desirability, reflecting a likelihood of future sales. Most desirable customers may, for example, be placed within group A, customers scoring as slightly less desirable may be placed within groups B, C, and D, with group D indicating a least desirable group of customers.

Such customer ranking services may also rank prospective customers (e.g., prospects) into a plurality of groups, such as group A, group B, group C, and group D, based upon a variety of factors used to distinguish prospects with whom relationships are more likely to generate future revenue or lead to generation of such revenue. For example, such factors may represent considerations such as how much business each prospect has done with other companies in competition with or in partnership with the user, or whether the user is currently engaged in a campaign for a specific product the customer has previously purchased. These and other factors may be used to rank or group prospects by desirability, reflecting a likelihood of future sales. Most desirable prospects may, for example, be placed within group A, prospects scoring as slightly less desirable may be placed within groups B, C, and D, with group D indicating a least desirable group of prospects.

Each of the user's customers may be associated within the customer datasets of the CRM platform with either a current customer ranking (e.g., within group A—indicating highest projected sales, to group D—indicating lowest projected sales) or a prospective customer ranking (e.g., within group A—indicating highest likelihood of establishing sales relationship, to group D—indicating lowest projected likelihood of establishing sales relationship) for customers with whom the user has not yet established a sales relationship. By allowing users to select specific current and prospective customer rankings as criticality factors for determining an optimal frequency for upcoming customer meetings, the customer contact ranked scheduling assistance system intelligently ranks the importance of upcoming customer meetings according to likelihood that a successful sales relationship may be created and maintained.

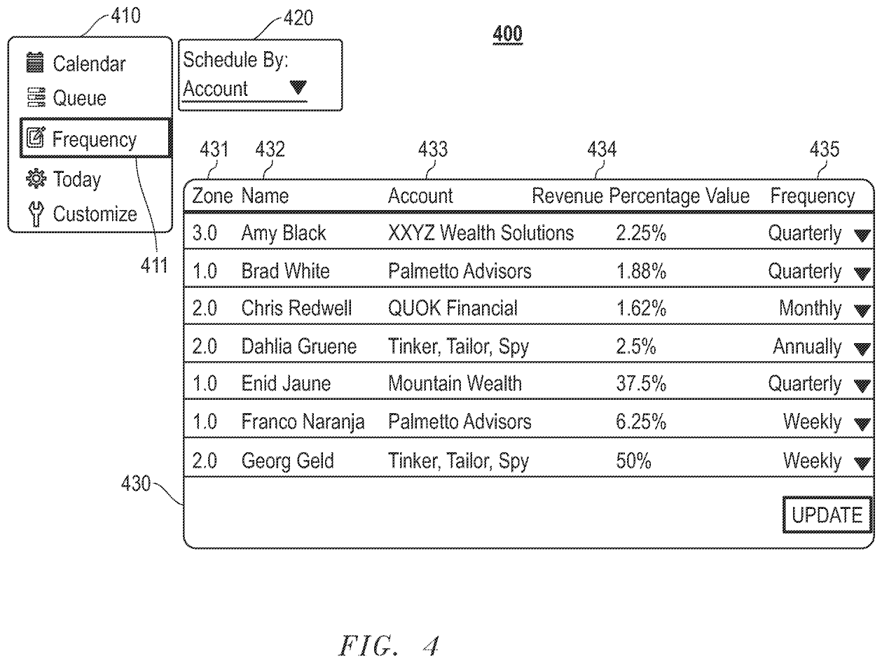

The user may identify one of the listed dataset fieldnames or descriptions 334 in an embodiment as a user-selected dataset fieldname defined by the user as a criticality factor for determining an optimal frequency for upcoming customer meetings by, for example, ticking or selecting a box beside the listed dataset fieldname (e.g., annual revenue percentage 335a). Other embodiments contemplate other known methods for selecting a displayed item, including, for example, selection from a drop-down menu, highlighting, clicking a link, or manually entering the dataset fieldname via a dialogue box. The user may then select the apply button 337 to instruct the customer contact ranked scheduling assistance system in an embodiment to store an identification of the selected dataset fieldname (e.g., revenue percentage value 335a, or previous success rate 336a) as a user-selected dataset fieldname defined by the user as a criticality factor for determining an optimal frequency for upcoming customer meetings. In such a way, the user may select one or more types of information (e.g., revenue percentage value 335a or previous success rate 336a), already maintained by a remote information management platform, as a factor critical to the determination of an optimal frequency for upcoming customer meetings for optimization of the user's business. This customization of the frequency window in an embodiment may affect the types of information displayed within the frequency window, as described in greater detail with respect to FIG. 4, below.

FIG. 3B is a graphical illustration depicting a customize window of a graphical user interface (GUI) allowing a user to identify criticality factors for ranking upcoming customer meetings, based on selected criticality or urgency factors according to an embodiment of the present disclosure. As described herein, the queue window in an embodiment may list a ranked order of meetings with customers the user needs to schedule, based on a user-defined frequency, or on factors identified by the user or a manager as critical for determining an optimal chronological order for upcoming customer meetings. In some embodiments, such as an embodiment described with reference to FIG. 9, the customer contact ranked scheduling assistance system may rank the urgency of scheduling meetings with a plurality of customers based on the likelihood such a meeting may generate revenue for the user of the GUI, and the volume of such revenue anticipated. In other embodiments, as described in FIG. 3B, the user may select other types of information for the customer contact ranked scheduling assistance system to use in determining urgency of scheduling meetings. These various types of information, either used by default (e.g., revenue percentage value, previous success rate), or selected by the user as described with reference to FIG. 3B may constitute criticality factors for determining an optimal chronological order of scheduling upcoming customer meetings in various embodiments.

At 338, the user may select the queue window in order to customize the information displayed via the GUI (e.g., GUI 400 described below with reference to FIG. 4) within the queue window (e.g., 430). As also described herein, this queue of upcoming meetings may also sort or rank the upcoming meetings according to the criticality factors identified by the user as critical for determining a chronological order for upcoming customer meetings. This may be tailored to optimize the user's business from a revenue standpoint, an efficiency standpoint, or for other customer reasons. For example, the user may select from the list of dataset fieldnames 334 a factor (e.g., revenue percentage value 335a or previous success rate 336a) identified by the user as a criticality factor for determining an optimal chronological order for upcoming customer meetings.

The user of the customer contact ranked scheduling assistance system in an embodiment may also specify combinations of criticality factors. For example, the user may select both the revenue percentage value 335a and the previous success rate 336a as criticality factors for determining the optimal chronological order in which upcoming customer meetings should be set. In such an embodiment, the customer contact ranked scheduling assistance system may determine the rank for a plurality of customers with whom meetings need to be set by taking into account both the percentage of the user's revenue attributable to each customers and the previous success rate for each of the customers, as described in greater detail with respect to FIG. 9, below.

As described herein, although the user may wish to consider multiple criticality factors (e.g., revenue percentage value 335a and previous success rate 336a) when determining urgency of upcoming meetings, the user may not consider these factors to be equally important. Thus, when ranking urgency of upcoming meetings according to a plurality of criticality factors in such a way, the customer contact ranked scheduling assistance system may allow the user to assign weights to each of these criticality factors (e.g., 335a and 336a). For example, the user may assign, using the GUI, a first weight 335b (e.g., 0.5) to consideration of the revenue percentage value for each of the customers, and assign a second weight 336b (e.g., 0.2) to consideration of the previous success rate for each of the customers. In such a way, the user may indicate or otherwise adjust the relative importance of each of the criticality factors in determining urgency of upcoming meetings. The customer contact ranked scheduling assistance system in an embodiment described below with respect to FIG. 9 may then apply these weights to the plurality of criticality factors used to determine urgency of upcoming meetings with each of the plurality of customers.

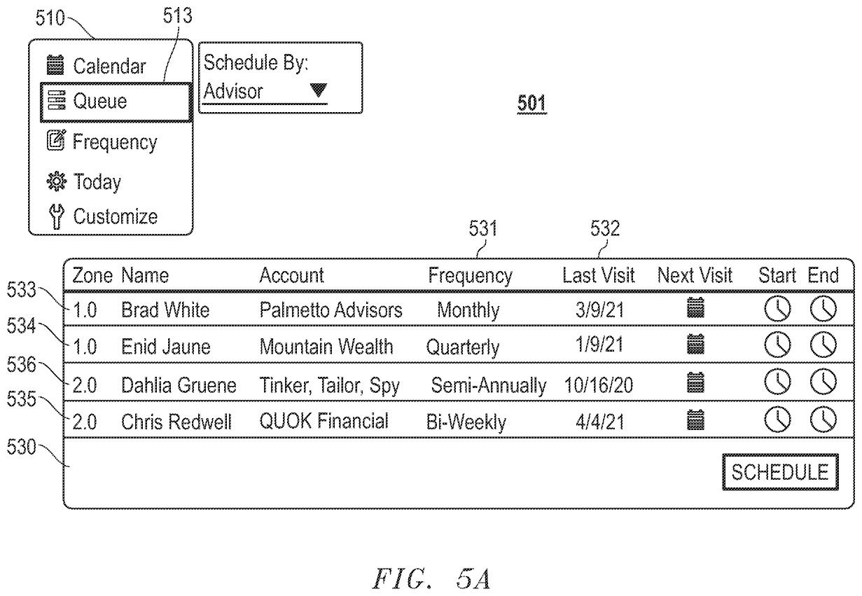

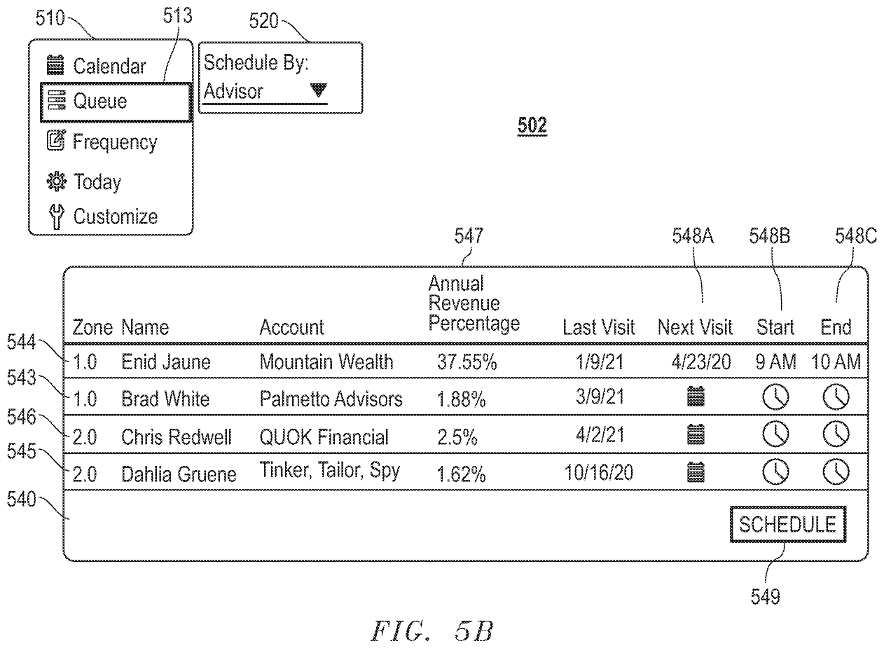

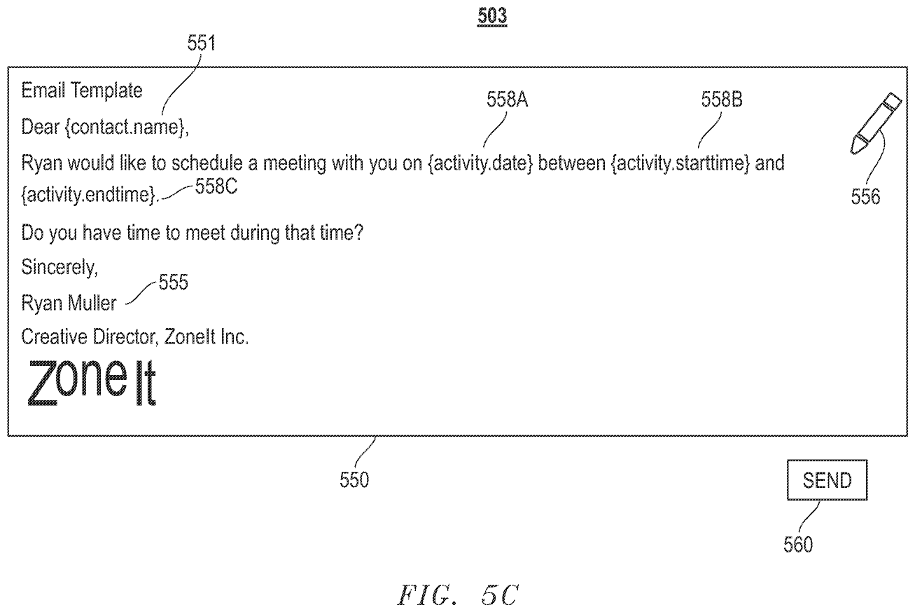

Upon selection by the user of the apply button 337, the customer contact ranked scheduling assistance system may store an association between the user-specified weighting value 335b (e.g., 0.5) and the user-selected criticality factor (e.g., revenue percentage value 335a) for determining an optimal chronological order for upcoming customer meetings. This customization of the queue window in an embodiment may affect the order in which each account or customer is displayed within the queue window for scheduling of upcoming meetings, as described in greater detail with respect to FIG. 5B, below.

FIG. 4 is a graphical illustration depicting a frequency window of a graphical user interface (GUI) 400, including customer information identified by a user or manager as critical to determining optimal meeting frequency according to an embodiment of the present disclosure. As described above, with reference to FIG. 3A, the customize window in an embodiment may allow the user or a manager to select one or more dataset fieldnames (e.g., revenue percentage value 434) as critical to determining an optimal frequency for upcoming customer meetings. Following such a customization, and upon later selection of the frequency window tab 411 within the window menu 410 in an embodiment, the customer contact ranked scheduling assistance system may identify the user-selected dataset fieldname (e.g., revenue percentage value 434) as a criticality factor for determining an optimal frequency for upcoming customer meetings. The customer contact ranked scheduling assistance system may then direct the GUI 400 to display the user-selected dataset fieldname (e.g., revenue percentage value 434) within the frequency window 430. The GUI 400 may also display the dataset value associated at the CRM platform with the user-selected dataset fieldname (e.g., revenue percentage value 434) as a criticality factor for determining an optimal frequency for upcoming customer meetings, for each of a plurality of customers. The user may then use the drop-down menus in the frequency column 435 to provide user-selected meeting frequency values for each of the plurality of customers, similar to embodiments described with reference to FIG. 2, above.

FIG. 5A is a graphical illustration depicting a queue window of a graphical user interface (GUI) 500 for viewing a list of and scheduling upcoming customer meetings according to an embodiment of the present disclosure. As described herein, the customer contact ranked scheduling assistance system in embodiments may provide a list of customers with whom the user needs to set upcoming meetings, ranked according to likelihood such customer may generate revenue for the user, in order to prompt the user to set meetings with each of the customers in an order most likely to maximize revenues and maintain healthy business relationships across an entire customer base. The queue window 530 in an embodiment may list such a ranked order of meetings with customers the user needs to schedule, based on a user-defined frequency, or on factors (e.g., revenue percentage value or previous success rate) identified by the user or a manager as critical for determining an optimal chronological order for upcoming customer meetings. Selection by the user of the queue window tab 513 in an embodiment may initiate display via GUI 500 of a queue window 530, listing several accounts or customers, to allow the user to select one of the accounts or customers for scheduling of an upcoming meeting. The queue window 530 may display basic customer information identifying each customer, including the name of the customer, or the customer's business or employer (e.g., mountain wealth industries). The user may then select a customer or account to schedule an upcoming meeting, based on the retrieved and displayed customer information.

The queue window 530 may list the accounts, or customers with whom upcoming meetings need to be scheduled according to various schemes in various embodiments. For example, the queue window 530 may list the accounts, or customers according to a past due percentage value, determined based on the date of most recent meeting and the user-selected meeting frequency value (shown in column 531). As described above with reference to FIGS. 2 and 4, the user or a manager may set an optimal meeting frequency, or a default frequency for each customer, client, or patient. Following application of a default meeting frequency, or a user-selected meeting frequency value, the customer contact ranked scheduling assistance system may access the user's electronic calendar (e.g., via Outlook®, Google® Calendar, or any other cloud-based, electronic, or online calendaring application), and identify the date of most recent meeting, or the date on which the user most recently met with each of a plurality of customers, clients, or patients (e.g., as shown in the last visit column 532). The customer contact ranked scheduling assistance system may then determine a meeting deadline date for each customer by adding the number of days identified within the user-selected meeting frequency value (or default frequency) to the date on which the user most recently met with each customer.

The customer contact ranked scheduling assistance system may also determine a past due value by dividing the number of days that have elapsed between the meeting deadline date (assuming that date occurred in the past) and the current date by the number of days in the user-selected meeting frequency value. This is done to establish a past due criticality factor value. For example, the Palmetto Advisors account shown in line 533 of the queue window 530 may display a user-specified or default frequency value of one month (e.g., in column 531), and a most recent meeting date of Mar. 9, 2021 (e.g., in column 532). The customer contact ranked scheduling assistance system may then determine a meeting deadline date of Apr. 9, 2021 for the Palmetto Advisors account. If the meeting deadline date (e.g., Apr. 9, 2021) for a meeting with Palmetto Advisors occurred six days ago (e.g., if the current date is Apr. 15, 2021), the past due value for the account shown in row 533 of the queue window 530 may be six divided by thirty, or 0.2. As another example, the Mountain Wealth account shown in line 534 of the queue window 530 may display a user-specified or default frequency value of one quarter (e.g., in column 531), and a most recent meeting date of Jan. 9, 2021 (e.g., in column 532). The customer contact ranked scheduling assistance system may then determine a meeting deadline date of Apr. 9, 2021 for the Mountain Wealth account. If the meeting deadline date for a meeting with Mountain Wealth occurred six days ago (e.g., if the current date is Apr. 15, 2021), the past due value for the account shown in row 534 of the queue window 530 may be six divided by ninety, or 0.0667. The GUI 300 may display the accounts in queue window 530 according to each of these past due values in an embodiment. For example, the queue window 530 may display each of the accounts in descending order of past value, with the Palmetto Advisors account, having a past due value of 0.2 at the top, followed by the Mountain Wealth account having a past due value 0.00667. The customer contact ranked scheduling assistance system may thus list several potential upcoming meetings, ranked in descending order by the past due value.

FIG. 5B is a graphical illustration depicting a queue window of a graphical user interface (GUI) 500 for viewing a ranked list of and scheduling upcoming customer meetings according to an embodiment of the present disclosure. The GUI 500 may display the list of suggested upcoming customer meetings in the queue window 530 according to a criticality ranking determined based on a combination of the past due value and the revenue percentage value or the previous success rate. In other embodiments, the ranking of customers within the queue window 530 may be determined based on one or more user-selected criticality factors for determining an optimal chronological order for upcoming customer meetings.

As described above with respect to FIG. 3B, a user may select such criticality factors (e.g., revenue percentage value 335a or previous success rate 336a) via a customize window 330 from a list of dataset fieldnames retrieved from the user's CRM platform or other information management platform. The user may also provide a weighting value (e.g., 0.5 at 335b or 0.2 at 336b in FIG. 3B) to indicate a degree to which this criticality factor should influence the criticality ranking for each account. A weighted criticality value may be determined for each of the plurality of customers or accounts by multiplying the weighting value by the value for the user-selected criticality factor (e.g., revenue percentage value 335a or previous success rate 336a) stored at the user's CRM platform, as described in greater detail below with respect to FIG. 8. For example, a weighted criticality value may be determined by multiplying the user-specified weighted value of 0.5 (e.g., 335b in FIG. 3B) by the revenue percentage values for each of a plurality of customers or accounts at the user's CRM platform.

More specifically, returning to FIG. 5B, the customer contact ranked scheduling assistance system may retrieve the revenue percentage value of 37.55% associated with the Mountain Wealth account from the user's CRM platform, and display this value (e.g., in column 547) within a criticality-ranked queue window 540. The customer contact ranked scheduling assistance system may determine a weighted revenue percentage value for the Mountain Wealth account in such an embodiment by multiplying the user-specified revenue weighting value of 0.5 by the revenue percentage value of 37.55% for Mountain Wealth, for a weighted revenue percentage value of 0.18775. This weighted revenue percentage value in an embodiment may then be added to the past due value of 0.0667 associated with the Mountain Wealth account (e.g., as described above with reference to FIG. 5A), to generate a criticality ranking of 0.25425 for the Mountain Wealth account.

As another example, the customer contact ranked scheduling assistance system may retrieve the revenue percentage value of 1.88% associated with the Palmetto Advisors account from the user's CRM platform, and display this value (e.g., in column 547) within a criticality-ranked queue window 540. The customer contact ranked scheduling assistance system may determine a weighted revenue percentage value for the Palmetto Advisors account in such an embodiment by multiplying the user-specified revenue weighting value of 0.5 by the retrieved revenue percentage value of 1.88% for Palmetto Advisors, for a weighted criticality value of 0.0094. This weighted criticality value in an embodiment may then be added to the past due value of 0.2 associated with the Palmetto Advisors account (e.g., as described above with reference to FIG. 5A), to generate a criticality ranking of 0.2094 for the Palmetto Advisors account.

The ranked queue window 540 in an embodiment may display each of a plurality of customers or accounts according to their associated criticality rankings. For example, the ranked queue window 540 may place the Mountain Wealth account, associated with a criticality ranking of 0.25425 at the top of the list, with the Palmetto Advisors account, associated with a criticality ranking of 0.2094 listed next. This may be in contrast to the order of accounts shown in the queue window 530 of FIG. 3A, determined based on past due values alone, which placed the Palmetto Advisors account ahead of the Mountain Wealth account in criticality. The differences in the order of accounts shown in FIGS. 5A and 5B in an embodiment may reflect the added consideration in FIG. 5B of the revenue percentage value that is attributable to each customer or account. In such a way, the customer contact ranked scheduling assistance system may provide an order in which the user should schedule upcoming meetings with customers, clients, or patients in order to optimize the users' business performance.

In other embodiments, other user-selected dataset fieldnames may be defined as a criticality factor for determining an optimal chronological order for upcoming customer meetings. For example, a user may identify a previous success rate indicating a percentage of previous meetings with each customer or account that have resulted in user sales, as described in greater detail below with respect to FIGS. 8 and 9. Still other examples may include, for example, a measure of an online reviewer's posting frequency or volume, an average rating provided by an online reviewer, or a diagnosis for a patient, as described in greater detail below with respect to FIG. 7. In some embodiments, multiple criticality factors for determining an optimal chronological order for upcoming customer meetings may be selected by the user, and each of these multiple criticality factors may be given a weighting value. For example, a user may assign a weighting value of 0.5 or 50% to a revenue percentage value and assign a weighting value of 0.3 or 30% to previous success rate. In still other embodiments, a manager of a user may select one or more of the criticality factors for determining an optimal chronological order for upcoming customer meetings, or the weighting values associated with these factors.

The user may also use the queue window 540 to select one or more accounts for scheduling from the queue of future meetings in an embodiment. The user may click a calendar icon within the next visit column 548A of the ranked queue window 540 in order to select or enter a future meeting date. For example, the user may enter or select at 548A a future meeting date of Apr. 23, 2021 (e.g., one week from a current date of Apr. 16, 2021) with Enid Jaune at Mountain Wealth. The user may further select a start time of 9 AM in column 548B and an end time of LOAM in column 548C for this meeting. Upon selecting the schedule button 549 in an embodiment, the customer contact ranked scheduling assistance system may generate a form e-mail to the named contact for that account (e.g., Enid Jaune of Mountain Wealth), based on the user-provided start time (e.g., 9 AM), end time (e.g., 10 AM), and date (e.g., Apr. 23, 2021), as described in greater detail with respect to FIG. 5C directly below. The customer contact ranked scheduling assistance system may also transmit a request to the user's electronic calendar application to generate an electronic appointment for the user at the user-provided start time (e.g., 9 AM), and date (e.g., Apr. 23, 2021), as described in greater detail with reference to FIG. 1.

The customer contact ranked scheduling assistance system in an embodiment may retrieve this stored information. For example, in an embodiment described with reference to FIG. 5B, the customer contact ranked scheduling assistance system may retrieve data from the CRM platform indicating $10,000,000 of the user's annual revenue totaling $26,631,158 for the fiscal year of 2020 were attributable to sales made to Enid Jaune of Mountain Wealth. In such an example, the customer contact ranked scheduling assistance system may determine a revenue percentage value for Enid Jaune of 37.55%. As another example, the customer contact ranked scheduling assistance system may retrieve data indicating $500,665 of the user's annual revenue totaling $26,631,158 for the fiscal year of 2020 were attributable to sales made to Brad White of Palmetto Advisors. In such an example, the customer contact ranked scheduling assistance system may determine a revenue percentage value for Brad White of 1.88%. In some embodiments, the CRM platform itself may have already stored an annual revenue percentage value by performing this same methodology.

FIG. 5C is a graphical illustration depicting a form e-mail for scheduling a future meeting with a customer or account advisor, based on a user-selected date and meeting time, according to an embodiment of the present disclosure. The customer contact ranked scheduling assistance system may generate a form e-mail 550 to a named contact 551 for an account, based on a user-provided start time 558B, end time 558C, and date 558A, input via the GUI, as described above with reference to FIG. 5B. The contact name 551 and contact e-mail address may be retrieved by the customer contact ranked scheduling assistance system from the user's CRM platform or other information management platform and inserted into the form e-mail 550. Similarly, the values input into the GUI described with reference to FIG. 5B for the date, start time, and end time may be inserted into the form e-mail 550.

The form e-mail 550 may be approved by the user or automatically transmitted to the named contact 551 via communication with the user's e-mail platform. In some embodiments, the user may edit the form e-mail 550 by selecting the edit icon 556, prior to transmission. The customer contact ranked scheduling assistance system in embodiments may communicate with an API of the user's e-mail platform to transmit such a form e-mail 550, and may communicate with an API of the user's electronic calendar to store a calendar appointment on the user-defined date 558A, at the user-defined start time 558B. In some embodiments, storage of such an appointment at the user's electronic calendar may occur after the named contact accepts the e-mail invitation to such an appointment. In some embodiments, the calendar appointment may also be stored at the electronic calendar for a manager of the user, allowing such a manager to easily view the user's (e.g., salesperson) activities for the day.

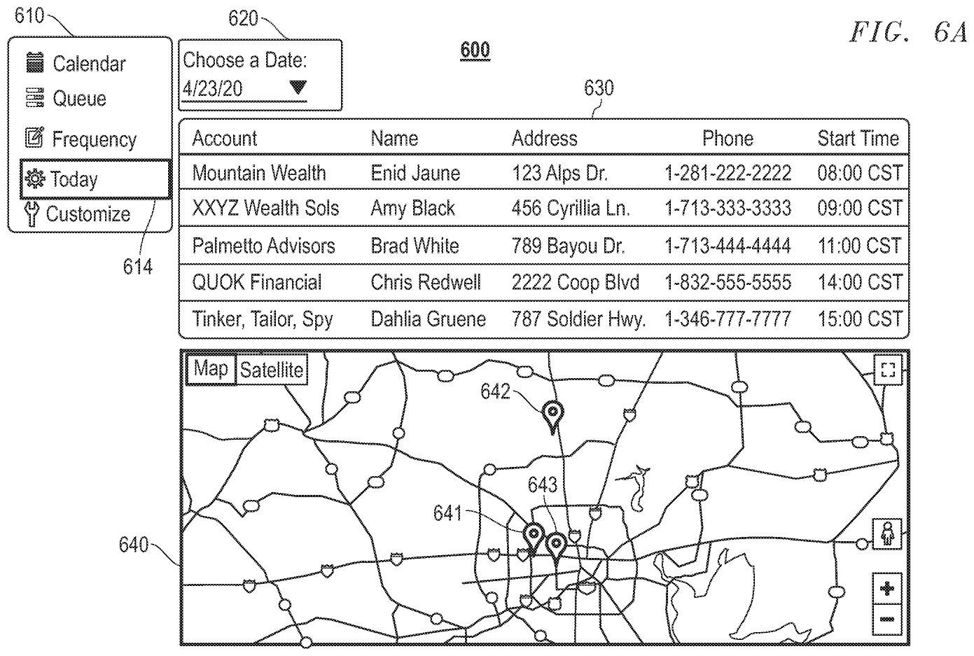

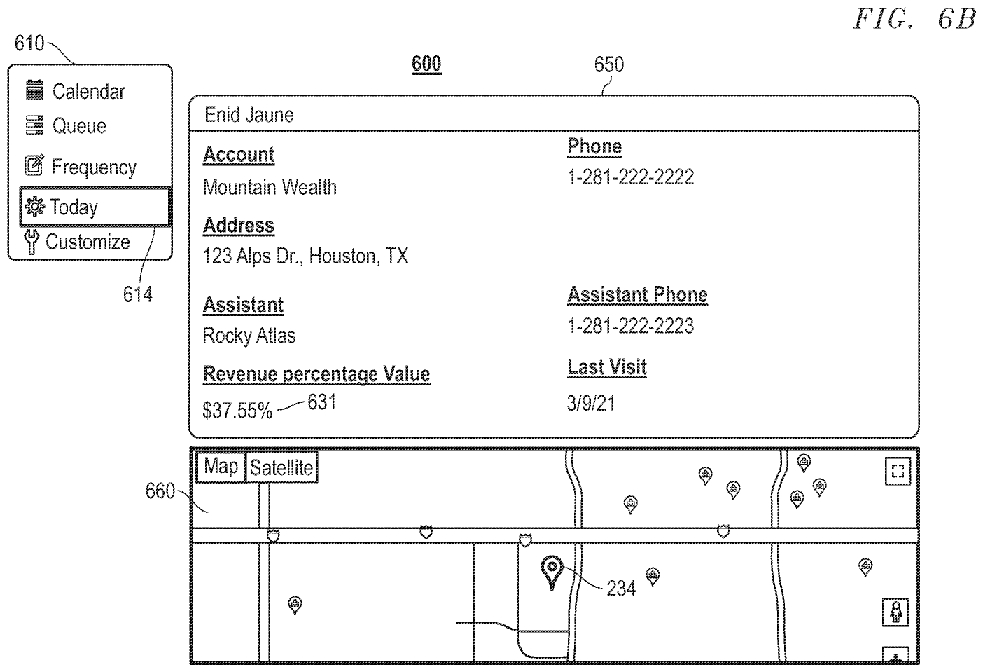

FIG. 6A is a graphical illustration depicting a daily information window of a graphical user interface (GUI) 600 for displaying information for one or more customer meetings scheduled for a user-specified date according to an embodiment of the present disclosure. As described herein, the daily information window in an embodiment may list a plurality of meetings currently scheduled for a user-specified date, along with various customer information relating to these meetings. For example, the user may select a date (e.g., Apr. 23, 2020) for display via a date selection box 620. The user may make such a selection through various known input techniques, including a drop down menu, manual dialogue box entry, or selection from an electronic calendar.

The customer contact ranked scheduling assistance system may retrieve all appointments or electronic calendar meetings for the user-specified date (e.g., Apr. 23, 2021) from the user's electronic calendar platform. The customer contact ranked scheduling assistance system may further communicate with the user's CRM platform or other information management platform to retrieve customer, client, or patient information associated with the contact name identified within the retrieved calendar appointments. For example, the customer contact ranked scheduling assistance system may retrieve the account associated with the named contact, the address, phone, appointment start time, or other information (e.g., meeting frequency, revenue percentage value, previous success rate, assistant's contact information) from the CRM platform. The GUI 600 may display this customer or account information within a daily information window 630. In embodiments, the customer contact ranked scheduling assistance system may also communicate with a mapping platform to generate a map 640 showing each of the retrieved addresses for the meetings set to occur on the user-specified date (e.g., Apr. 23, 2021). The customer contact ranked scheduling assistance system may then display the map 640 via the GUI 600, to provide the user with a snapshot or summary of information about each of the meetings that are set to occur on the user-specified date, as well as a map 640 of each of the locations where the meetings are scheduled to occur on a select day.

FIG. 6B is a graphical illustration depicting a customer contact information window 650 of a graphical user interface (GUI) 600 according to an embodiment of the present disclosure. As described herein, a user may seek more in-depth information about a given meeting in embodiments of the present disclosure by selecting one of the meetings scheduled for the user-selected date and listed in the daily information window (e.g., 630 in FIG. 6A). For example, upon selecting or clicking on one of the listed meetings, the customer contact ranked scheduling assistance system may display a customer contact information window 650 listing all information retrieved from the CRM platform or other information management platform for the given account or contact (e.g., Enid Jaune of Mountain Wealth), including revenue percentage value, previous success rate, date of last visit, contact information for an assistant, or any other information stored by the user and associated with that account at the CRM platform or other information management platform. The GUI 600 may display the revenue percentage value 531 used to determine the criticality ranking for one of the customers or accounts (e.g., Enid Jaune of Mountain Wealth). In other embodiments, other factors (e.g., previous success rate) used by the customer contact ranked scheduling assistance system to determine the criticality rankings for the customers may be displayed within GUI 600. The customer contact ranked scheduling assistance system in embodiments may also communicate with the mapping platform to retrieve a more detailed or localized map 660 for that specific meeting, and display this more detailed map 660 with the detailed information for the named contact or account. In such a way, the customer contact ranked scheduling assistance system may gather, organize, and display information drawn from several disparate platforms (e.g., user's electronic calendar, mapping platform, user's CRM platform) upon the user's request (e.g., selection of a given date via the GUI) to provide varying levels of information about the user's upcoming meetings.

FIG. 7 is a flow diagram illustrating a method of defining criticality factors for use in ranking customers according to urgency of scheduling upcoming meetings according to an embodiment of the present disclosure. As described herein, the customize window in an embodiment may allow the user or a manager to select one or more dataset fieldnames (e.g., revenue percentage value or previous success rate) as critical to determining an optimal frequency or optimal chronological order for upcoming customer meetings.

At block 702, the customer contact ranked scheduling assistance system in an embodiment may receive an identification of a user's customer resource management (CRM) platform or other type of information management platform, as well as any security information required to access that platform. For example, in an embodiment described with reference to FIG. 1, user 102 or her organization may store information about customer 104 that the user 102 or her organization finds most important or pertinent to the performance of their business at the CRM platform 140. The user 102 may provide the customer contact ranked scheduling assistance system with an IP address at which the customer contact ranked scheduling assistance system can communicate with the CRM API 142. The customer contact ranked scheduling assistance system in an embodiment may also gather from user 102 credentials needed to access information about customer 104 through the CRM API 142, via a graphical user interface (GUI) 130.

The customer contact ranked scheduling assistance system in an embodiment may access the CRM platform or other information management platform to identify dataset fieldnames associated with one or more customers or accounts at block 704. For example, in an embodiment described with reference to FIG. 1, the customer contact ranked scheduling assistance system 126 in an embodiment may request and receive, via the CRM API 142 information about customer 104 as described herein, such as contact information, location, industry, revenue percentage value or previous success rate. CRM 140 may store such information within customer datasets 144, as managed and controlled by the user 102, or the user's organization. In other embodiments, customer, client, or patient information accessed by the customer contact ranked scheduling assistance system may be stored in other types of platforms or databases, including online review filter platforms (e.g., Vivial®), or various medical patient portals, for example.

User 102 or her organization may store information about customer 104 that the user 102 or her organization finds most important or pertinent to the performance of their business. A list of the types of information stored at customer datasets 144 of CRM 140, including name, position, account number, employer/business, industry, phone, address, revenue percentage value or previous success rate may be retrieved by the customer contact ranked scheduling assistance system 126. This information may be stored at in the form of datasets, with each dataset containing a dataset fieldname (e.g., “address”) and a dataset field value (e.g., “789_Bayou_dr”).

At block 706, a graphical user interface (GUI) for the customer contact ranked scheduling assistance system may display a list of dataset fieldnames associated with customers within the CRM platform, prompting the user to customize one or more GUI windows to display user-selected customer information represented by the dataset fieldnames. For example, in an embodiment described with reference to FIG. 1, the customer contact ranked scheduling assistance system 126 in an embodiment may display these dataset 144 fieldnames or descriptions thereof via the GUI 130 for selection by the user 102 as a criticality factor for determining an optimal chronological order or an optimal frequency for upcoming customer meetings. The customer contact ranked scheduling assistance system 126 may display a list of dataset 144 fieldnames retrieved from CRM platform 140 via the GUI 130, including name, position, account number, employer/business, industry, phone, address, revenue percentage value or previous success rate. In another embodiment described with reference to FIGS. 3A and 3B, the customize window 330 may display a list 334 of dataset fieldnames retrieved from a CRM platform via the GUI, including zone, account, name, city, state, address, frequency, last visit, next visit, revenue percentage value, previous success rate, industry, or account age.

The customer contact ranked scheduling assistance system may determine at block 708 whether the user wishes to customize the frequency window of the GUI. For example, in an embodiment described with reference to FIG. 3A, selection by the user of the customize window tab 312 in an embodiment may initiate display via GUI 300 of a customize window 330, listing one or more GUI windows 331 that may be customized, including, for example, the calendar window, the queue window, the frequency window, or the daily information window. At 332, the user may select the frequency window in order to customize the information displayed via the GUI (e.g., GUI 200 described above with reference to FIG. 2) within the frequency window (e.g., 230). Selection of the frequency window at 332 may indicate the user wishes to customize the frequency window of the GUI. If the user wishes to customize the frequency window of the GUI, the method may proceed to block 710 for customization of the frequency window. If the user does not wish to customize the frequency window, the method may proceed to block 714 to determine whether the user wishes to customize the queue window of the GUI.

At block 710, in an embodiment in which the user wishes to customize the frequency window of the GUI, the customer contact ranked scheduling assistance system may receive a user selection of dataset fieldnames defined by the user as a criticality factor for determining an optimal frequency for repeating customer meetings in the future. For example, in an embodiment described with reference to FIG. 1, the user 102 may select, via the GUI 130, revenue percentage value or previous success rate as a criticality factor for determining an optimal frequency for repeating customer meetings. As another example, in an embodiment described with reference to FIG. 3A, the user may identify one of the listed dataset fieldnames or descriptions 334 in an embodiment as a user-selected dataset fieldname defined by the user as a criticality factor for determining an optimal frequency for upcoming customer meetings by, for example, ticking or selecting a box beside the listed dataset fieldname (e.g., revenue percentage value 335a or previous success rate 336a).

The customer contact ranked scheduling assistance system in an embodiment may store in memory an identification of the user-selected dataset fieldname defined by the user as a criticality factor for determining an optimal frequency for upcoming customer meetings at block 712. For example, in an embodiment described with reference to FIG. 3A, the user may select the apply button 337 to instruct the customer contact ranked scheduling assistance system in an embodiment to store an identification of the selected dataset fieldname (e.g., revenue percentage value 335a or previous success rate 336a) as a user-selected dataset fieldname defined by the user as a criticality factor for determining an optimal frequency for upcoming customer meetings. In such a way, the user may select one or more types of information (e.g., revenue percentage value 335a or previous success rate 336a), already maintained by a remote information management platform, as a factor critical to the determination of an optimal frequency for upcoming customer meetings for optimization of the user's business.

At block 714, the customer contact ranked scheduling assistance system may determine whether the user wishes to customize the queue window of the GUI. For example, in an embodiment described with reference to FIG. 3B, the queue window in an embodiment may list a ranked order of meetings with customers the user needs to schedule, based on a user-defined frequency, or on factors identified by the user or a manager as critical for determining an optimal chronological order for upcoming customer meetings. At 337, the user may select the queue window in order to customize the information displayed via the GUI (e.g., GUI 400 described below with reference to FIG. 4) within the queue window (e.g., 430). Selection of the queue window at 337 may indicate the user wishes to customize the queue window of the GUI. If the user wishes to customize the queue window of the GUI, the method may proceed to block 716. If the user does not wish to customize the queue window of the GUI, the method for customization of one or more windows of the GUI may be complete and the method may end.

The customer contact ranked scheduling assistance system in an embodiment in which the user wishes to customize the queue window of the GUI may receive a user selection of a dataset fieldname stored in the CRM platform defined by the user as a criticality factor for determining an optimal chronological order for scheduling upcoming customer meetings across a plurality of customers at block 716. For example, in an embodiment described with reference to FIG. 3A, the user may select from the list of dataset fieldnames 334 a factor (e.g., customer ranking value, prospect ranking value, new product campaign, total sales to date) identified by the user as a criticality factor for determining an optimal chronological order for upcoming customer meetings. This may be particularly useful, for example, during a concerted campaign to sell a specific type of product or to clear stored inventory prior to a close of a fiscal year. As described herein, each of the user's customers may be associated within the customer datasets of the CRM platform with either a current customer ranking (e.g., within group A—indicating highest projected sales, to group D—indicating lowest projected sales) or a prospective customer ranking (e.g., within group A—indicating highest likelihood of establishing sales relationship, to group D—indicating lowest projected likelihood of establishing sales relationship) for customers with whom the user has not yet established a sales relationship. By allowing users to select specific current and prospective customer rankings as criticality factors for determining an optimal frequency for upcoming customer meetings, the customer contact ranked scheduling assistance system intelligently ranks the importance of upcoming customer meetings according to likelihood that a successful sales relationship may be created and maintained.

As another example, in an embodiment described with reference to FIG. 3B, the user may select from the list of dataset fieldnames 334 a factor (e.g., revenue percentage value 335a or previous success rate 336a) identified by the user as a criticality factor for determining an optimal chronological order for upcoming customer meetings. Upon selection of one of the dataset fieldnames 334 as a factor identified by the user as a criticality factor for determining an optimal chronological order for upcoming customer meetings, the GUI 330 may prompt the user to further identify a weight to be assigned to this factor for determining the rank or urgency of each customer meeting. For example, if the user identifies revenue percentage value 335a as a factor critical to determination of meeting priority, the GUI 330 may provide a dialogue box 335b in which the user may enter a weighting value between zero and one, or a percentage value. This weighting value may indicate the degree to which the user believes the criticality factor should affect the chronological order in which upcoming customer meetings are scheduled. For example, the user may assign a weighting value of 50% or 0.5.

At block 718, the customer contact ranked scheduling assistance system in an embodiment may store in memory an identification of the user-selected dataset fieldname defined by the user as a criticality factor for determining an optimal chronological order for upcoming customer meetings. For example, upon selection by the user of the apply button 337, the customer contact ranked scheduling assistance system may store an association between the user-specified weighting value (e.g., 0.5 at 335b or 0.3 at 336b) and the user-selected criticality factor (e.g., revenue percentage value or previous success rate at 335a or previous success rate at 336a) for determining an optimal chronological order for upcoming customer meetings. The identification of the user-selected dataset fieldname defined by the user as a criticality factor for determining an optimal chronological order for upcoming customer meetings, and an association with the user-selected weighting value may be stored at a memory of the computing device executing the customer contact ranked scheduling assistance system in an embodiment. In another embodiment, the identification of the user-selected dataset fieldname defined by the user as a criticality factor for determining an optimal chronological order for upcoming customer meetings, and an association with the user-selected weighting value may be stored at the user's CRM platform or other information management platform. The method for customizing one or more windows of the GUI may then end.

FIG. 8 is a flow diagram illustrating a method of determining criticality factor values used to gauge urgency of upcoming meetings for each of a plurality of customers according to an embodiment of the present disclosure. As described herein, one of the most difficult challenges for salespersons or other professionals needing to routinely meet with customers, clients, or patients in order to maintain a healthy business involves scheduling such meetings in order to maintain those professional relationships. Many professionals meet with customers, clients, or patients that are located over a widespread geographic area, and those meetings may occur at different frequencies. This makes it difficult to develop a repeatable pattern of meetings likely to maintain all these professional relationships. The customer contact ranked scheduling assistance system of the present application addresses these issues by suggesting the scheduling of meeting dates with customers, clients, or patients, given in a prioritized order of urgency, determined at least based on a likelihood such meetings will result in revenue for the user, and volume of such revenue. The impact of these criticality factors in determining urgency to schedule meetings may be adjustable by a user in the customer contact ranked scheduling assistance system according to an embodiment.

At block 802, the customer contact ranked scheduling assistance system in an embodiment may identify one of a plurality of customers as the customer of interest. For example, in an embodiment described with reference to FIG. 2, the user of the customer contact ranked scheduling assistance system may have accounts with Mountain Wealth Industries, Palmetto Advisors, QUOK Financial Management, Inc., Tinker, Tailer, Spy Management, and XXYZ Wealth Solutions, Inc. In such an embodiment, the customer contact ranked scheduling assistance system may identify Mountain Wealth Industries as the customer of interest at block 802.

The customer contact ranked scheduling assistance system in an embodiment may set a meeting frequency value for the customer of interest to a default value at block 804. For example, meetings with customers may be set to occur weekly, monthly, or quarterly. As another example, meetings with customers may be set to occur at a preset time period following a sale of an item, such as within one week, month, quarter, or other duration of such a sale. In yet another example, meetings with patients may be set to occur annually.

At block 806, the customer contact ranked scheduling assistance system may determine whether the user has reset the meeting frequency in an embodiment. For example, in an embodiment described with reference to FIG. 2, the user may provide a user-selected meeting frequency value for a given account or contact via a drop down menu 232 in an embodiment. The drop-down menu 232 in an embodiment may be populated with a plurality of meeting frequency options 233, such as, for example, weekly, bi-weekly, monthly, quarterly, semi-annually, or annually. The user may select the user-selected meeting frequency value (e.g., quarterly) by selecting or clicking on one of these available meeting frequency options 233 within the drop-down menu 232. If the user has reset the meeting frequency, the method may proceed to block 808 by resetting the meeting frequency for the customer of interest based on user input received via the GUI. If the user has not reset the meeting frequency, the method may proceed to block 810 to set a meeting deadline for the customer of interest.

The customer contact ranked scheduling assistance system in an embodiment may reset the meeting frequency value for the customer of interest based on the user input received via the GUI at block 808. For example, in an embodiment described with reference to FIG. 2, the user may use the drop down menu 232 to change the frequency of meetings with Mountain Wealth Industries from a default value of monthly to a user-specified frequency of quarterly. In such an embodiment, the customer contact ranked scheduling assistance system may store an association between the customer Mountain Wealth Industries and a frequency of quarterly. This association may be stored at the CRM platform in some embodiments, or at a server maintained, operated, or controlled by the customer contact ranked scheduling assistance system in other embodiments, for example. The method may then proceed to block 810 to set a meeting deadline for the customer of interest.

At block 810, the customer contact ranked scheduling assistance system in an embodiment may set the meeting deadline date for the customer of interest by adding the number of days within the meeting frequency value to the date upon which the most recent meeting with the customer of interest occurred. For example, in an embodiment described with reference to FIG. 5A, the customer contact ranked scheduling assistance system may set the meeting deadline date for Enid Jaune, shown in row 534, to occur on Apr. 9, 2021, which is one fiscal quarter, three months, or 90 days after the last visit date of Jan. 9, 2021. As another example, the customer contact ranked scheduling assistance system may set the meeting deadline date for Brad White, shown in row 533, to occur on Apr. 9, 2021, which is one month or 30 days after the last visit date of Mar. 9, 2021. In yet another example, the meeting deadline date for Dahlia Gruene may be set to Apr. 16, 2021, or six months from the last meeting date of Oct. 16, 2020.

The customer contact ranked scheduling assistance system in an embodiment may determine a previous success rate for the customer of interest by dividing the number of previous meetings that have resulted in sales by the total number of previous meetings with the customer of interest at block 812. Many users of the customer contact ranked scheduling assistance system may store such information at a CRM platform, as a means of tracking sales performance over time across a plurality of customers. The customer contact ranked scheduling assistance system in an embodiment may retrieve this stored information. For example, the customer contact ranked scheduling assistance system may retrieve data indicating the user has had twenty previous meetings with a first customer named Enid Jaune with Mountain Wealth, ten of which resulted in sales. In such an example, the customer contact ranked scheduling assistance system may determine a previous success rate for Enid Jaune of 50%. As another example, the customer contact ranked scheduling assistance system may retrieve data indicating the user has had ten previous meetings with a second customer named Brad White of Palmetto Advisors, three of which resulted in sales. In such an example, the customer contact ranked scheduling assistance system may determine a previous success rate for Brad White of 30%. In some embodiments, the CRM platform itself may have already stored a previous success rate by performing this same methodology.

At block 814, the customer contact ranked scheduling assistance system in an embodiment may determine a weighted previous success rate for the customer of interest by multiplying the previous success rate by a preset previous success rate weighting value for the customer of interest. The preset previous success rate weighting value may be defined by the customer contact ranked scheduling assistance system in some embodiments. For example, the customer contact ranked scheduling assistance system may set the previous success rate weighting value to a default value. This default value may be, for example, 0.2 or 20%. In other embodiments, the default value may have any value between zero and one, reflecting a weighting percentage. The default value in some embodiments may be determined based on various factors, such as the user's industry. Thus the preset or user-defined previous success rate weighting value establishes the relative importance or impact of the previous success rate criticality factor in determining criticality ranking for the customer of interest, as described further in FIG. 9. Further, user defined weighting values allow for adjustability by the user of the impact in the customer contact ranked scheduling assistance system operations to generate a criticality ranking for scheduling customer meetings.

In some example embodiments, the user of the customer contact ranked scheduling assistance system may provide a user-defined or default previous success rate weighting value via the GUI. For example, in an embodiment described with reference to FIG. 3B, the user may have specified a previous success rate weighting value of 0.2 at 336b. In such an example, the customer contact ranked scheduling assistance system may determine a weighted previous success rate for the customer Enid Jaune to be 0.1 by multiplying the previous success rate of 50% by the user-defined previous success rate weighting value of 0.2. In another example, the customer contact ranked scheduling assistance system may determine a weighted previous success rate for the customer Brad White to be 0.06 by multiplying the previous success rate of 30% by the user-defined previous success rate weighting value of 0.2.

The weighted previous success rate may be determined in embodiments in which the user has specifically assigned a weighting value to the previous success rate, or in which the user has designated a plurality of criticality factors (e.g., both the previous success rate and the revenue percentage value) for determining urgency of scheduling upcoming customer meetings for optimization of user revenue, as described in greater detail with respect to FIG. 9. In some embodiments, block 814 may be skipped, and the method of FIG. 9 may still be used to determine a ranked list of customers, ordered according to urgency for setting of upcoming meetings.

The customer contact ranked scheduling assistance system in an embodiment may determine a revenue percentage value for the customer of interest by dividing the revenue generated through sales to the customer of interest by the user's total revenue at block 816. Many users of the customer contact ranked scheduling assistance system may store such information at a CRM platform, as a means of tracking sales performance over time across a plurality of customers. The customer contact ranked scheduling assistance system in an embodiment may retrieve this stored information. For example, in an embodiment described with reference to FIG. 5B, the customer contact ranked scheduling assistance system may retrieve data from the CRM platform indicating $10,000,000 of the user's annual revenue totaling $26,631,158 for the fiscal year of 2020 were attributable to sales made to Enid Jaune of Mountain Wealth. In such an example, the customer contact ranked scheduling assistance system may determine a revenue percentage value for Enid Jaune of 37.55%. As another example, the customer contact ranked scheduling assistance system may retrieve data indicating $500,665 of the user's annual revenue totaling $26,631,158 for the fiscal year of 2020 were attributable to sales made to Brad White of Palmetto Advisors. In such an example, the customer contact ranked scheduling assistance system may determine a revenue percentage value for Brad White of 1.88%. In some embodiments, the CRM platform itself may have already stored an annual revenue percentage value by performing this same methodology.

At block 818, the customer contact ranked scheduling assistance system in an embodiment may determine a weighted revenue percentage value for the customer of interest by multiplying the revenue percentage value by a user-defined revenue weighting value. A user defined revenue weighting value may be defined by the customer contact ranked scheduling assistance system in some embodiments. In other embodiments, the customer contact ranked scheduling assistance system may set the revenue weighting value to a default value. This default value may be, for example, 0.5 or 50% in an example embodiment. In other embodiments, the default value may have any value between zero and one, reflecting a weighting percentage. The default value in some embodiments may be determined based on various factors, such as the user's industry. Thus the preset or user-defined revenue weighting value establishes the relative importance or impact of the revenue percentage value criticality factor in determining criticality ranking for the customer of interest, as described further in FIG. 9. Further, user defined weighting values allow for adjustability by the user of the impact in the customer contact ranked scheduling assistance system operations to generate a criticality ranking for scheduling customer meetings. In an embodiment in which multiple criticality factors (e.g., annual revenue percentage, previous success rate) have been assigned preset weighting values, the preset weighting values for each of the factors may be used by a user respectively to adjust the importance or impact of each criticality factor on criticality rankings according to embodiments described herein (e.g., with respect to FIG. 9).

In some example embodiments, the user of the customer contact ranked scheduling assistance system may provide a default or user defined previous success rate weighting value via the GUI. For example, in an embodiment described with reference to FIG. 3B, the user may have specified a revenue percentage weighting value of 0.5 at 335b. In such an example, the customer contact ranked scheduling assistance system may determine a weighted previous success rate for the customer Enid Jaune to be 0.18775 by multiplying the revenue percentage value of 37.55% or 0.3755 by the user-defined previous success rate weighting value of 0.5. In another example, the customer contact ranked scheduling assistance system may determine a weighted previous success rate for the customer Brad White to be 0.0094 by multiplying the revenue percentage value of 1.88% or 0.0188 by the user-defined previous success rate weighting value of 0.5.

The weighted revenue percentage value may be determined in embodiments in which the user has specifically assigned a weighting value to the revenue percentage value, or in which the user has designated a plurality of criticality factors (e.g., both the previous success rate and the revenue percentage value) for determining urgency of scheduling upcoming customer meetings for optimization of user revenue, as described in greater detail with respect to FIG. 9. In some embodiments, block 818 may be skipped, and the method of FIG. 9 may still be used to determine a ranked list of customers, ordered according to urgency for setting of upcoming meetings.

The customer contact ranked scheduling assistance system in an embodiment may determine at block 820 whether all customers to be considered have been assigned deadlines, revenue percentage values or weighted revenue percentage values, and success rate percentage values or weighted success rate percentage values. For example, the customer contact ranked scheduling assistance system in an embodiment may determine whether the customers Dahlia Gruene and Chris Redwell have also been assigned revenue percentage values or weighted revenue percentage values, and success rate percentage values or weighted success rate percentage values. If all customers have not been assigned deadlines, revenue percentage values or weighted revenue percentage values, and success rate percentage values or weighted success rate percentage values, the method may proceed to block 822 for selection of another customer of interest. If all customers have been assigned deadlines, revenue percentage values or weighted revenue percentage values, and success rate percentage values or weighted success rate percentage values, all information necessary to rank a plurality of customers according to likelihood upcoming meetings will result in revenue for the user may have been collected and generated, and the method proceed to block 824 for determination of zone criticality factors.

At block 822, the customer contact ranked scheduling assistance system in an embodiment may identify the next customer not yet assigned a deadline, revenue percentage or weighted revenue percentage value, and success rate percentage value or weighted success rate percentage value as the next customer of interest. For example, in an embodiment described with reference to FIG. 2, the user of the customer contact ranked scheduling assistance system may have accounts with Mountain Wealth Industries, Palmetto Advisors, QUOK Financial Management, Inc., Tinker, Tailer, Spy Management, and XXYZ Wealth Solutions, Inc. In an embodiment in which the customer contact ranked scheduling assistance system has assigned a meeting deadline, a weighted revenue percentage value, and a weighted success rate percentage value to Mountain Wealth Industries, as described at blocks 810, 814, and 818, the customer contact ranked scheduling assistance system may identify Palmetto Advisors as the next customer of interest at block 822.

The method may then proceed back to block 804 to set a meeting frequency value for the next customer of interest. By repeating the loop between blocks 804 and 822 for each of a plurality of customers, the customer contact ranked scheduling assistance system in an embodiment may gather or generate all information needed to rank importance or urgency of scheduling upcoming meeting with each of these customers, based on the likelihood such a meeting will generate revenue for the user, as described in greater detail with respect to FIG. 9.

The customer contact ranked scheduling assistance system in an embodiment in which all customers have been assigned deadlines, weighted revenue percentage and weighted success rates may determine at block 824, for each geographical zone, a zone criticality factor gauging the urgency of meeting with customers or prospects within each geographical zone. A user may wish to schedule several customer meetings that are in the same geographical zone within the same time period (e.g., one day, one week), if several of the most urgent upcoming meetings fall within this single geographical zone. In other words, the fact that several of the customers' criticality factors are high, combined with the fact that these customers are located within the same geographical zone may increase the overall criticality of meeting with each of these customers, as described in greater detail with respect to block 928 of FIG. 9 below.

A zone criticality factor in an embodiment may be determined by multiplying the percentage of all current and prospective customers that are within the geographical zone by an average revenue percentage value for all customers in the geographic zone. For example, in an embodiment in which 7.8% of all of the user's customers and prospective customers are located within a single geographical zone (e.g., downtown Houston), and the average revenue percentage value associated with all customers within this geographical zone is 42.1%, the zone criticality for downtown Houston may be 3.2838. In another example, in an embodiment in which 22% of all of the user's customers and prospective customers are located within another geographical zone (e.g., the Woodlands), and the average revenue percentage value associated with all customers within this geographical zone is 12.6%, the zone criticality for the Woodlands may be 2.772. In some embodiments, this zone criticality factor may be weighted according to customer ranking (e.g., customer groups A, B, C, or D), or according to prospect ranking (e.g., prospect groups A, B, C, or D). Further, the zone criticality factor may be weighted according to a percentage of customers or prospects targeted for a specific sales campaign. The method may then end.

The method for determining criticality factor values (e.g., revenue percentage value, weighted revenue percentage value, success rate percentage value, or weighted success rate percentage value) used to gauge urgency of upcoming meetings for each of a plurality of customers may then end.

FIG. 9 is a flow diagram illustrating a method of generating a contact criticality list, ranked according to urgency, of customers with whom a user needs to schedule upcoming meetings, where the degree of urgency depends upon expected revenue derived from one or more criticality factors for each customer, according to an embodiment of the present disclosure. As described herein, the customer contact ranked scheduling assistance system may prompt a user to schedule upcoming meetings with customers by listing these customers in a prioritized order of urgency, determined based on a likelihood such meetings will result in revenue for the user, or volume of such revenue.

At block 902, the customer contact ranked scheduling assistance system in an embodiment may receive a user request to display a current customer meeting queue for a plurality of customers. For example, in an embodiment described with respect to FIG. 1, the customer contact ranked scheduling assistance system 126 may retrieve data for a plurality of a user's 102 customers (e.g., 104) stored within customer datasets 144 at the CRM platform 140. This data may include names of a plurality of customers with whom the user 102 regularly meets, with whom the user 102 needs to set an upcoming meeting, or with whom the user 102 has already scheduled an upcoming meeting. For example, this data may identify a customer “Brad White,” and another customer “Enid Jaune.” This retrieval of customer data from the CRM platform 140 may occur according to routine polling practices of the customer contact ranked scheduling assistance system 126 in an embodiment. In another embodiment, this may occur pursuant to a direct user instruction received via the GUI 130. In still other embodiments, this may occur any time the user 102 logs into or otherwise accesses the GUI 130.

The customer contact ranked scheduling assistance system in an embodiment may identify one of the plurality of customers as a customer of interest at block 904. For example, the customer contact ranked scheduling assistance system may identify Brad White as the customer of interest. As another example, customer contact ranked scheduling assistance system may identify Enid Jaune as the customer of interest.

At block 906, the customer contact ranked scheduling assistance system in an embodiment may determine whether a meeting has already been scheduled with the customer of interest. As described herein, the customer contact ranked scheduling assistance system may provide a list of customers with whom the user needs to set upcoming meetings in order to prompt the user to set meetings with each of the customers in an order most likely to maximize revenues and maintain healthy business relationships across an entire customer base. If the user has already scheduled a meeting with the customer of interest, the customer of interest may not need to be listed within the contact criticality list in the queue, or may be placed at the bottom of the queue, indicating a lack of urgency in scheduling a next meeting. For example, the user may have already set a meeting with Chris Redwell of QUOK Financial. If a meeting has not yet been scheduled with the customer of interest, the method may proceed to block 908 to gauge the urgency of setting an upcoming meeting with the customer of interest. If a meeting has already been scheduled with the customer of interest, there may be no urgency to schedule another meeting with the customer of interest, and the method may proceed to block 910 to set the criticality ranking for the customer of interest to a value of zero.

The customer contact ranked scheduling assistance system in an embodiment in which an upcoming meeting has not yet been scheduled with the customer of interest may determine whether the meeting deadline date associated with the customer of interest has already passed at block 908. For example, the meeting deadline date for Dahlia Gruene may have been set to Apr. 16, 2021, at block 810 of FIG. 8. As another example, the meeting deadline dates for both Brad White and Enid Jaune may have been set for Apr. 9, 2021, as also described above at block 810 of FIG. 8. If the user requests a ranked queue of customers on Apr. 15, 2021, the customer contact ranked scheduling assistance system in an embodiment may determine the meeting deadline date associated with Dahlia Gruene has not yet occurred, but that the meeting deadlines for both Brad White and Enid Jaune have passed. The method may then proceed to block 912 to further gauge the urgency of setting an upcoming meeting with the customer of interest, based on the likelihood such a meeting will result in revenue for the user.

At block 910, the customer contact ranked scheduling assistance system may set the criticality ranking for the customer of interest to a value of zero. This may occur, for example, in an embodiment in which an upcoming meeting has already been scheduled with the customer of interest, as determined at block 906. For example, the user may have already set a meeting with Chris Redwell of QUOK Financial, and the customer contact ranked scheduling assistance system may assign Chris Redwell a criticality ranking of zero. This may also occur, as another example, in an embodiment in which the meeting deadline date has not yet passed, as determined at block 908. For example, the customer contact ranked scheduling assistance system may have determined the meeting deadline date associated with Dahlia Gruene has not yet occurred, and the customer contact ranked scheduling assistance system may assign Dahlia Gruene a criticality ranking of zero. In both of these situations, there may be little to no urgency to set an upcoming meeting deadline. By setting the criticality ranking for the customer of interest in these situations to zero, the customer contact ranked scheduling assistance system in an embodiment may ensure that the customer of interest is placed at or near the bottom of the queue of customers with whom the user is prompted to set upcoming meetings, as described in greater detail with respect to block 928, below. The method may then proceed to block 924 to determine whether all customers have been assigned a criticality ranking.

In an embodiment in which the user has not yet scheduled a meeting with the customer of interest, and in which the deadline date for scheduling such a meeting has already passed, the customer contact ranked scheduling assistance system may determine a past due value for the customer of interest at block 912. The customer contact ranked scheduling assistance system in an embodiment may determine such a past due value by determining the number of days that have elapsed since the meeting deadline date assigned to the customer of interest. For example, in an embodiment described with respect to FIG. 5A, the customer contact ranked scheduling assistance system may determine a past due value of six days that have elapsed between the meeting deadline date of Apr. 9, 2021 and the queue request date of Apr. 15, 2021. As another example, the customer contact ranked scheduling assistance system may determine a past due value of six days that have elapsed between the meeting deadline date of Apr. 9, 2021 and the queue request date of Apr. 15, 2021.

At block 914, the customer contact ranked scheduling assistance system in an embodiment may determine a past due percentage value for the customer of interest by dividing the past due value for that customer by the meeting frequency value assigned to that customer. For example, in an embodiment described with respect to FIG. 5A, the customer contact ranked scheduling assistance system may determine a past due percentage value of 0.2 for Brad White at row 533 by dividing the six days that have elapsed between the meeting deadline date of Apr. 9, 2021 and the queue request date of Apr. 15, 2021 by the thirty days within the meeting frequency value associated with Brad White. As another example, the customer contact ranked scheduling assistance system may determine a past due percentage value of 0.0667 for Enid Jaune at row 534 by dividing the six days that have elapsed between the meeting deadline date of Apr. 9, 2021 and the queue request date of Apr. 15, 2021 by the 90 days within the meeting frequency value associated with Enid Jaune. The queue of customers shown in FIG. 5A may thus reflect a contact criticality list of the customers, ranked according to past due percentage value alone, or absent consideration of other criticality factors such as the revenue percentage value or previous success rate associated with the customers. Such a criticality ranking list may rank Brad White at the top, in row 533, with a past due percentage value of 0.2, Enid Jaune at row 534 with a past due percentage value 0.0667, Dahlia Gruene at row 536 with a past due percentage value of zero, and Chris Redwell at row 535 with a past due percentage value of zero.

The customer contact ranked scheduling assistance system may determine at block 916 whether one or more criticality factors have been assigned a weighting value by the user. As described herein, the customer contact ranked scheduling assistance system in an embodiment may suggest the scheduling of meeting dates with customers, clients, or patients, given in a prioritized order of urgency, determined based on a likelihood such meetings will result in revenue for the user, and volume of such revenue. The customer contact ranked scheduling assistance system may prioritize customers in such a way by weighting the ranking with one or more criticality factors, such as revenue percentage value or previous success rate describing likelihood that an upcoming meeting with the customer will result in revenues for the user. These are only two examples of criticality factors that may be considered in such a prioritization to weight the contact criticality list ranking from the past due percentage value. For example, as described at block 716 with respect to FIG. 7 above, the user may identify one or more other dataset fieldnames for other information or metrics stored at a CRM platform describing the user's previous sales relationship with each of the customers to be used as criticality factors, such as current or prospective customer ranking values, association of customers with specifically identifiable sales campaigns, or total sales to a given customer to date.

As also described herein, the user of the customer contact ranked scheduling assistance system may specify combinations of criticality factors, and the user may not consider these factors to be equally important. Thus, when ranking urgency of upcoming meetings according to a plurality of criticality factors in such a way, the customer contact ranked scheduling assistance system may allow the user to assign a user defined weight to adjust the weight or impact of each of these criticality factors. As described above with reference to FIG. 3B, the user may assign a weight of 0.5 or 50%, using the GUI at 335b to adjust consideration of the revenue percentage value for each of the customers, and assign a weight of 0.2 or 20% at 336b to adjust consideration of the previous success rate for each of the customers. If an adjustment weighting value has not been assigned, the method may proceed to block 918 to determine a criticality ranking that is not adjusted. If an adjustment weighting value has been assigned by a user, the method may proceed to block 920 to determine an adjusted weighted criticality ranking.

At block 918, in an embodiment in which the user has not assigned an adjusted weighting value to any of the identified criticality factors, such as revenue percentage value or previous success rate, the customer contact ranked scheduling assistance system may weight the criticality ranking for the customer of interest based on the revenue-related criticality factor values. In some embodiments, the customer contact ranked scheduling assistance system in such an embodiment may determine the criticality ranking weighted for the customer of interest by adding the past due percentage value to either the previous success rate or the revenue percentage value. For example, the customer contact ranked scheduling assistance system may in an embodiment may determine a criticality ranking of 0.2188 for Brad White of Palmetto Advisors by summing the past due percentage value of 0.2 and the revenue percentage value of 0.0188. As another example, the customer contact ranked scheduling assistance system may in an embodiment may determine a criticality ranking of 0.4422 for Enid Jaune of Mountain Wealth by summing the past due percentage value of 0.0667 and the revenue percentage value of 0.3755. In still another example, the customer contact ranked scheduling assistance system may in an embodiment may determine a criticality ranking of 0.5 for Brad White of Palmetto Advisors by summing the past due percentage value of 0.2 and the previous success rate of 0.3 or 30%. As yet another example, the customer contact ranked scheduling assistance system may in an embodiment may determine a criticality ranking of 0.7 for Enid Jaune of Mountain Wealth by summing the past due percentage value of 0.2 and the previous success rate of 0.5 or 50%. In still other embodiments, the customer contact ranked scheduling assistance system may multiple or normalize the past due percentage value or various criticality factors to weight criticality ranking by criticality factors.

In other embodiments, the customer contact ranked scheduling assistance system in such an embodiment may determine the criticality ranking for the customer of interest by weighting the past due percentage value by plural criticality factors, such as the previous success rate and the revenue percentage value. For example, the customer contact ranked scheduling assistance system may determine a criticality ranking of 0.5188 for Brad White of Palmetto Advisors by adding together the past due percentage value of 0.2, the previous success rate of 0.3, and the revenue percentage value of 0.0188. As another example, the customer contact ranked scheduling assistance system may determine a criticality ranking of 0.9422 for Enid Jaune by adding together the past due percentage value of 0.0667, the previous success rate of 0.5, and the revenue percentage value of 0.3755. These values may have been determined, as described above with respect to block 914, and blocks 812 and 816 of FIG. 8. Adding the past due percentage value, the previous success rate, and the revenue percentage value together in such a way essentially assigns equal weighting to each of these factors. In still other embodiments, the customer contact ranked scheduling assistance system may multiple or normalize the past due percentage value or various criticality factors to weight criticality ranking by criticality factors. The method may then proceed to block 922 to determine whether criticality rankings have been assigned to each of the plurality of customers.

Returning to block 916, the customer contact ranked scheduling assistance system in an embodiment in which the user has assigned adjusted weighting values to one or more of the criticality factors, such as revenue percentage value or previous success rate may determine a weighted criticality ranking at block 920 that takes these user adjusted weighting values into account. In some embodiments, the customer contact ranked scheduling assistance system in such an embodiment may determine the adjusted weighted criticality ranking for the customer of interest by adding, multiplying, or normalizing the past due percentage value with either the adjusted weighted previous success rate or the adjusted weighted revenue percentage value or both. For example, the customer contact ranked scheduling assistance system may in an embodiment may determine a criticality ranking of 0.2094 for Brad White of Palmetto Advisors by summing the past due percentage value of 0.2 and the user adjusted weighted revenue percentage value of 0.0094. As another example, the customer contact ranked scheduling assistance system may in an embodiment may determine a criticality ranking of 0.25445 for Enid Jaune of Mountain Wealth by summing the past due percentage value of 0.0667 and the user adjusted weighted revenue percentage value of 0.18775. In still another example, the customer contact ranked scheduling assistance system may in an embodiment may determine a criticality ranking of 0.26 for Brad White of Palmetto Advisors by summing the past due percentage value of 0.2 and the user adjusted weighted previous success rate of 0.06. As yet another example, the customer contact ranked scheduling assistance system may in an embodiment may determine a criticality ranking of 0.3 for Enid Jaune of Mountain Wealth by summing the past due percentage value of 0.2 and the user adjusted weighted previous success rate of 0.1.

In other embodiments, the customer contact ranked scheduling assistance system may determine a user adjusted weighted criticality ranking by adding the user adjusted weighted previous success rate and the user adjusted weighted revenue percentage value for the customer of interest. As described above, by adding together each of the past due percentage value, the revenue percentage value, and the previous success rate, the criticality ranking essentially applies equal weighting to each of these factors. In order to afford different weighting to each of these factors, each factor may be multiplied by a user adjusted weighting value prior to such an addition, multiplication, or normalization in an example embodiment. As described above with reference to FIG. 8 at block 814, the customer contact ranked scheduling assistance system may determine a user adjusted weighted previous success rate by multiplying the previous success rate by a user-defined previous success rate weighting value. For example, the customer contact ranked scheduling assistance system may determine a user adjusted weighted previous success rate of 0.1 for Enid Jaune and 0.06 for Brad White. As also described above with reference to FIG. 8 at block 818, the customer contact ranked scheduling assistance system may determine a user adjusted weighted revenue percentage value by multiplying the percentage revenue value by a user-defined revenue weighting value. For example, the customer contact ranked scheduling assistance system may determine user adjusted weighted revenue percentage values of 0.18775 for Enid Jaune and 0.0094 for Brad White.

The customer contact ranked scheduling assistance system in an embodiment may then determine a user adjusted weighted criticality ranking by adding together the past due percentage value, the user adjusted weighted previous success rate and the user adjusted weighted revenue percentage value for the customer of interest. For example, the customer contact ranked scheduling assistance system in an embodiment may determine a weighted criticality ranking of 0.2694 for Brad White by summing the past due percentage value of 0.2, the user adjusted weighted previous success rate of 0.06, and the user adjusted weighted revenue percentage value of 0.0094. As another example, the customer contact ranked scheduling assistance system in an embodiment may determine a weighted criticality ranking of 0.35445 for Enid Jaune by summing the past due percentage value of 0.0667, the user adjusted weighted previous success rate of 0.1, and the user adjusted weighted revenue percentage value of 0.18775. In such a way, the user may indicate and adjust the relative importance of each of the criticality factors in determining urgency of upcoming meetings.

In an embodiment in which the criticality ranking or the weighted criticality ranking has been determined, the customer contact ranked scheduling assistance system may determine at block 922 whether all customers have been assigned a criticality ranking or a weighted criticality ranking. For example, the customer contact ranked scheduling assistance system in an embodiment may determine a criticality ranking or weighted criticality ranking has been determined for Brad White, but not for Enid Jaune. If all customers have not yet been assigned a criticality ranking or a weighted criticality ranking, the method may proceed to block 924 for identification of the next customer of interest. If all customers have been assigned a criticality ranking or a weighted criticality ranking, the method may proceed to block 926 for display of a ranked queue of each of the plurality of customers listed in order of criticality ranking or weighted criticality ranking.

At block 924, in an embodiment in which one or more of the plurality of customers has not yet been assigned a criticality ranking or a weighted criticality ranking, the customer contact ranked scheduling assistance system may identify the next available customer not yet associated with a criticality ranking or a weighted criticality ranking as the next customer of interest. For example, in an embodiment in which the customer contact ranked scheduling assistance system in an embodiment determines a criticality ranking or weighted criticality ranking has been determined for Brad White, but not for Enid Jaune, the customer contact ranked scheduling assistance system may identify Enid Jaune as the next customer of interest at block 924. The method may then proceed back to block 906 to determine whether a meeting has already been scheduled with the Enid Jaune. By repeating the loop between blocks 906 and 924, the customer contact ranked scheduling assistance system may assign a criticality ranking to each of the plurality of customers, such that all of these customers may be listed within a ranked queue according to their criticality rankings or weighted criticality rankings.

In an embodiment in which each of the plurality of customers has been associated with a criticality ranking or a weighted criticality ranking, the customer contact ranked scheduling assistance system may determine at block 926 whether any of the zone criticality factors meet a threshold value. As described with respect to block 824 of FIG. 8 above, a user may wish to schedule several customer meetings that are in the same geographical zone within the same time period (e.g., one day, one week), if several of the most urgent upcoming meetings fall within this single geographical zone. As also described above with respect to block 824 of FIG. 8, a zone criticality factor may be determined by multiplying the percentage of all customers and prospective customers that are within the geographical zone by an average revenue percentage value for all customers in the geographical zone. If a zone is associated with a zone criticality factor meeting such a threshold value, this may indicate a need for the user to schedule several customer meetings that are within this same geographical zone within the same time period, and an urgency to do so. The zone criticality factor threshold value may be preset by the user via the GUI in an embodiment. This threshold value may be any number.

For example, in an embodiment in which the threshold value for zone criticality is 3, the downtown Houston geographical zone associated with a zone criticality value of 3.2838 may meet the threshold value for zone criticality. As another example, in an embodiment in which the threshold value for zone criticality is 3, the Woodlands geographical zone associated with a zone criticality value of 2.772 may not meet the threshold value for zone criticality. If the zone criticality factor meets the threshold value, the method may proceed to block 928 to display a list of customers according to their criticality factors, with each of the customers within the zone whose criticality factor meets the threshold value ranked at the top of the queue. If the zone criticality factor does not meet the threshold value, the method may proceed to block 930 to display a list of customers according to their criticality factors, without regard to their respective geographical zones.

At block 928, in an embodiment in which one or more zone criticality factors meet the threshold value, the GUI may display a list of all customers, beginning with customers within the zone having a criticality factor meeting the threshold value, ordered according to their associated criticality ranking within the queue window of the GUI. For example, such a list of customers may begin with a list of all customers and prospective customers located within the downtown Houston geographical zone. Each of these customers and prospective customers within downtown Houston may be ranked within the list according to their respective criticality rankings. The remainder of the user's customers and prospective customers (e.g., those not located within downtown Houston geographical zone) in such an embodiment may also be listed below this ranked list of customers and prospective customers within the downtown Houston geographical zone, also ranked according to their associated criticality rankings. The customers and prospective customers located within the downtown Houston geographical zone in such an embodiment may be listed above customers and prospective customers located outside the downtown Houston geographical zone, even if the criticality rankings for those outside the downtown Houston geographical zone are higher than the criticality rankings for those inside the downtown Houston geographical zone. In other words, the fact that several of the customers' criticality factors are high, combined with the fact that these customers are located within the same geographical zone may increase the overall criticality of meeting with each of these customers. In an embodiment in which multiple zones are associated with zone criticality factors meeting the threshold value, the list may begin with customers located within the zone associated with the highest zone criticality factor that also meets the threshold value. The customer list in such an embodiment may also proceed by listing customers within each of the remaining zones whose zone criticality factors meet the threshold value, ranked according to each zone's criticality factor. The method for generating a list, ranked according to urgency, of customers with whom a user needs to schedule upcoming meetings, where the degree of urgency depends upon expected revenue derived from each customer may then end.

In an embodiment in which none of the geographical zones are associated with a zone criticality factor meeting the threshold value, the customer contact ranked scheduling assistance system may display a list of all of the customers, ordered according to their associated criticality rankings, within the queue window of the GUI at block 926. For example, in an embodiment described with reference to FIG. 5B, the customer contact ranked scheduling assistance system GUI 502 may display a list of customers that begins with Enid Jaune at row 544, proceeds to Brad White at row 543, then Chris Redwell at row 546, and Dahlia Gruene at row 545. As described above with reference to block 910, Chris Redwell may have been assigned a criticality ranking of zero because his assigned meeting deadline has not yet passed, and Dahlia Gruene may have been assigned a criticality ranking of zero because an upcoming meeting with her has already been scheduled. As a consequence, Chris Redwell and Dahlia Gruene are shown in GUI 502 at the bottom of the queue of customers with whom the user needs to schedule upcoming meetings.

As described above with reference to block 918, in an embodiment in which the customer contact ranked scheduling assistance system determines the weighted criticality ranking by weighting the past due percentage value with the revenue percentage value, Brad White may be assigned a criticality ranking of 0.2188, and Enid Jaune may be assigned a criticality ranking of 0.4422. In another example embodiment in which the customer contact ranked scheduling assistance system determines the weighted criticality ranking by weighting the past due percentage value with the previous success rate, Brad White may be assigned a criticality ranking of 0.5 and Enid Jaune may be assigned a criticality ranking of 0.7. In still another example embodiment in which the customer contact ranked scheduling assistance system determines the weighted criticality ranking by weighting the past due percentage value with the revenue percentage value and the previous success rate, Brad White may be assigned a criticality ranking of 0.5188 and Enid Jaune may be assigned a criticality ranking of 0.9422. In each of these embodiments, the GUI may display Enid Jaune at the top of the queue (e.g., at row 544), with Brad White following directly beneath (e.g., at row 543) to reflect Enid Jaune having a higher assigned criticality ranking than Brad White.

As also described above with reference to block 920, in an embodiment in which the customer contact ranked scheduling assistance system determines the weighted criticality ranking by weighting the past due percentage value and the user adjusted weighted revenue percentage value, Brad White may be assigned a criticality ranking of 0.2094, and Enid Jaune may be assigned a criticality ranking of 0.25445. In another example embodiment in which the customer contact ranked scheduling assistance system determines the weighted criticality ranking by weighting the past due percentage value with the user adjusted weighted previous success rate, Brad White may be assigned a criticality ranking of 0.26 and Enid Jaune may be assigned a criticality ranking of 0.3. In still another example embodiment in which the customer contact ranked scheduling assistance system determines the weighted criticality ranking by weighting the past due percentage value with the user adjusted weighted revenue percentage value and the user adjusted weighted previous success rate, Brad White may be assigned a criticality ranking of 0.2694 and Enid Jaune may be assigned a criticality ranking of 0.35445. In each of these embodiments, the GUI may display Enid Jaune at the top of the queue (e.g., at row 544), with Brad White following directly beneath (e.g., at row 543) to reflect Enid Jaune having a higher assigned criticality ranking than Brad White.

In contrast, in an embodiment described with reference to FIG. 5A, where the customer contact ranked scheduling assistance system listed all customers with a criticality ranking within the queue according to past due percentage value alone, Brad White was listed at the top (e.g., row 533), with Enid Jaune listed second at row 534. By ranking customers based on weighting with the revenue percentage value and previous success rate, as described above with reference to block 918, the customer contact ranked scheduling assistance system in an embodiment may direct the user to concentrate more effort toward scheduling an upcoming meeting with the customer most likely to generate revenue to the user, either because that meeting is more likely to result in sales, or to result in higher sales volume.

The list of customers displayed within the Queue window of the GUI in accordance with block 928 or 930 may further be filtered by the user according to one or more filtering factors. For example, the list of customers generated at block 928 or 930 may be filtered to list customers within a specific geographical zone (e.g., downtown Houston), to show urgency of meeting with all customers within this geographical zone. As another example, the list of customers generated at block 928 or 930 may be filtered to list customers according to sales made to those customers to date. As yet another example, the list of customers generated at block 928 or 930 may be filtered to list customers according to their past due values. In still another example, the list of customers generated at block 928 or 930 may be filtered to list customers associated with specifically identified sales campaigns. The method for generating a list, ranked according to urgency, of customers with whom a user needs to schedule upcoming meetings, where the degree of urgency depends upon expected revenue derived from each customer may then end.

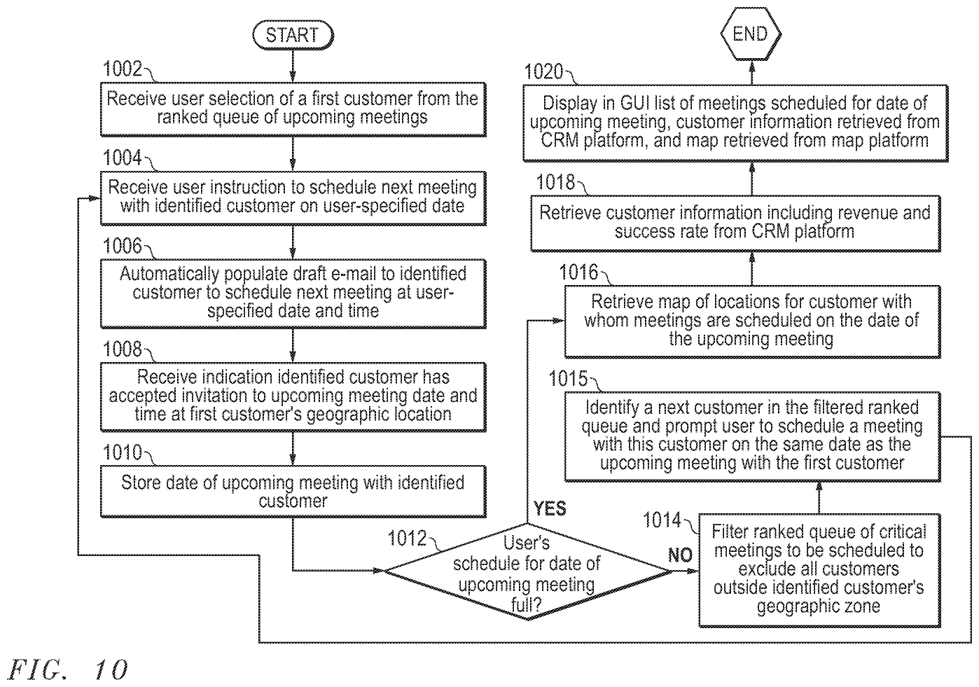

FIG. 10 is a flow diagram illustrating a method of displaying mapping, location, and customer or account information for upcoming meetings, scheduled according to urgency determined based on revenue and success rate according to an embodiment of the present disclosure. As described herein, the daily information window in an embodiment may list a plurality of meetings currently scheduled for a specific date, along with information used to determined urgency of such an upcoming meeting. Such a window may provide the user with a snapshot or summary of information describing why each of the meetings that are set to occur on that date are urgent, critical, or important to the user, as well as a map of each of the locations where the meetings are scheduled to occur.

At block 1002, a user selection of a first customer from the ranked queue of meetings that need to be scheduled may be received via a graphical user interface (GUI) in an embodiment. For example, in an embodiment described with reference to FIG. 5B, the GUI may display a ranked queue of meetings that need to be scheduled with a plurality of customers, including Enid Jaune and Brad White. As described above with reference to block 924 or FIG. 9, the customer contact ranked scheduling assistance system may generate this ranked list of customers according to a criticality ranking or a weighted criticality ranking determined for each of the plurality of customers.

A user instruction to schedule an upcoming meeting with the identified customer on a user-specified date may be received via the GUI in an embodiment at block 1004. For example, the user may click a calendar icon within the next visit column 548A of the ranked queue window 540 in order to select or enter a future meeting date. The user may enter or select at 548A a future meeting date of Apr. 23, 2021 (e.g., one week from a current date of Apr. 16, 2021) with Enid Jaune at Mountain Wealth, for example. The user may further select a start time of 9 AM in column 548B and an end time of LOAM in column 548C for this meeting.

At block 1006, the customer contact ranked scheduling assistance system in an embodiment may automatically populate a draft e-mail to the identified customer or account advisor to schedule the upcoming meeting at the user-specified date and time. For example, in an embodiment described with reference to FIG. 5B, upon selecting the schedule button 549 in an embodiment, the customer contact ranked scheduling assistance system may generate a form e-mail to the named contact for that account (e.g., Enid Jaune of Mountain Wealth), based on the user-provided start time (e.g., 9 AM), end time (e.g., 10 AM), and date (e.g., Apr. 23, 2021). In another example embodiment described with reference to FIG. 5C, the customer contact ranked scheduling assistance system may generate a form e-mail 550 to a named contact 551 for an account, based on a user-provided start time 558B, end time 558C, and date 558A, input via the GUI, as described above with reference to FIG. 5B. The contact name 551 and contact e-mail address may be retrieved by the customer contact ranked scheduling assistance system from the user's CRM platform or other information management platform and inserted into the form e-mail 550. Similarly, the values input into the GUI described with reference to FIG. 5B for the date, start time, and end time may be inserted into the form e-mail 550. The customer contact ranked scheduling assistance system in embodiments may communicate with an API of the user's e-mail platform to transmit such a form e-mail 550, and may communicate with an API of the user's electronic calendar to store a calendar appointment on the user-defined date 558A, at the user-defined start time 558B.

An indication that the identified customer has accepted the invitation to the upcoming meeting at the user-specified date and time may be received via the user's calendaring platform in an embodiment at block 1008. For example, in an embodiment described with reference to FIG. 1, the customer contact ranked scheduling assistance system 126 may receive an indication from the calendar API 112 that a new meeting has been scheduled with the customer 104. This may occur in some embodiments during routing polling of the calendar API 112 by the customer contact ranked scheduling assistance system 126.

At block 1010, the customer contact ranked scheduling assistance system in an embodiment may transmit the date of the upcoming meeting with the identified customer for storage at the CRM platform. For example, the customer contact ranked scheduling assistance system 126 may transmit information indicating that the new meeting has been scheduled with the customer 104 to the CRM platform 140 for storage within the customer datasets 144.

The customer contact ranked scheduling assistance system in an embodiment may determine at block 1012 whether the user's schedule for the date of the upcoming meeting with the identified customer is full. For example, the customer contact ranked scheduling assistance system 126 in an embodiment may determine whether the user's 102 schedule for the date of the upcoming meeting with customer 104 is full by polling or querying the calendar API 112. The customer contact ranked scheduling assistance system in some embodiments may do so pursuant to receipt of the indication from calendar API 112 that a new meeting has been scheduled with customer 104. In an embodiment in which the user's schedule for the date of the upcoming meeting with the identified customer is not full, this may indicate an opportunity to schedule other meetings nearby the identified customer on that date, and the method may proceed to block 1014 to identify another urgent meeting in the same vicinity as the identified customer. In an embodiment in which the user's schedule for the date of the upcoming meeting with the identified customer is full, the method may proceed to block 1016 to retrieve a map showing the locations for all customer meetings for that date.

At block 1014, in an embodiment in which the user's schedule for the date of the upcoming meeting is not yet full, the customer contact ranked scheduling assistance system may filter the ranked queue of critical meetings to be scheduled to exclude all customers outside the identified customer's geographic zone. For example, the customer contact ranked scheduling assistance system may filter the ranked queue of critical meetings generated and displayed at block 926 of FIG. 9, and from which the user selected the identified customer at block 1002 above. This ranked queue may be filtered to only include other customers that are located within the same geographic area as the customer selected by the user at block 1002. A geographic area or geographic zone in an embodiment may include, for example, an area within a two-hour driving radius, a metropolitan area, a city, a county, or a state. In some embodiments, the geographic zone may be preset or assigned to customers based on user input. In such a way, the customer contact ranked scheduling assistance system may narrow the ranked queue of critical meetings to be scheduled to include other customers located nearby the customer selected by the user at block 1002.

The customer contact ranked scheduling assistance system at block 1015 in an embodiment may prompt the user to schedule a meeting with the next customer in the filtered and ranked queue of meetings needing to be scheduled. Upon identification of the next most urgent meeting within the same geographic zone or area as the customer that the user identified at block 1002, the customer contact ranked scheduling system may prompt the user to schedule a meeting with this next most urgent customer on the same date as the upcoming meeting with the customer identified at block 1002. The method may then proceed back to block 1004, where the user may instruct the customer contact ranked scheduling system in an embodiment to schedule a next meeting with the customer identified at block 1015.

The loop between block 1004 and 1015 in an embodiment may be repeated until the user's schedule for the user-specified date is full. In such a way, the customer contact ranked scheduling assistance system in an embodiment may direct the user to schedule meetings according to an urgency defined by each customer's revenue and the user's success rate at making sales to such customers, and to group those meetings geographically in order to minimize travel time. The method may then proceed to block 1016 for retrieval of a map showing geographic locations for all meetings scheduled on a given date.

At block 1016, in an embodiment in which the user's schedule for a given date is full, the customer contact ranked scheduling assistance system may retrieve a map of all of the locations for customers with whom meetings have been scheduled on that given date. For example, the customer contact ranked scheduling assistance system 126 may also communicate with a mapping platform API 110 to generate a map showing each of the retrieved addresses for the meetings set to occur on the date on which the user 102 is scheduled to meet with the customer 104 (e.g., Apr. 23, 2021).

The customer contact ranked scheduling assistance system in an embodiment may retrieve customer information including revenue percentage value or previous success rate for a plurality of customers from the CRM platform at block 1018. For example, the customer contact ranked scheduling assistance system 126 may further communicate with the user's CRM platform 140 or other information management platform to retrieve customer, client, or patient information from customer datasets 144 associated with the participant names identified within the retrieved calendar appointments. For example, the customer contact ranked scheduling assistance system 126 may retrieve the account associated with the named participant (e.g., customer 104), the address, phone, appointment start time, or other information (e.g., meeting frequency, revenue percentage value, previous success rate, assistant's contact information) from the CRM platform 140.

At block 1020, a list of meetings scheduled for a given date may be displayed via the GUI, as well as the customer information retrieved from the CRM platform, and the map retrieved from the map platform. For example, in an embodiment described with reference to FIG. 6A, the GUI 600 may display this customer or account information within a daily information window 630. The customer contact ranked scheduling assistance system may then display the map 640 generated by the mapping platform via the GUI 600, to provide the user with a snapshot or summary of information about each of the meetings that are set to occur on the user-specified date, as well as a map 640 of each of the locations where the meetings are scheduled to occur. As another example, as described with reference to FIG. 6B, the GUI 600 may display the revenue percentage value 531 used to determine the criticality ranking for one of the customers or accounts (e.g., Enid Jaune of Mountain Wealth). In other embodiments, other factors (e.g., previous success rate) used by the customer contact ranked scheduling assistance system to determine the criticality rankings for the customers may be displayed within GUI 600. In such a way, the customer contact ranked scheduling assistance system and the GUI may provide the user with a snapshot or summary of information describing why each of the meetings that are set to occur on that date are urgent, critical, or important to the user, as well as a map of each of the locations where the meetings are scheduled to occur. The method for displaying mapping, location, and customer or account information for upcoming meetings, scheduled according to urgency determined based on revenue and success rate may then end.

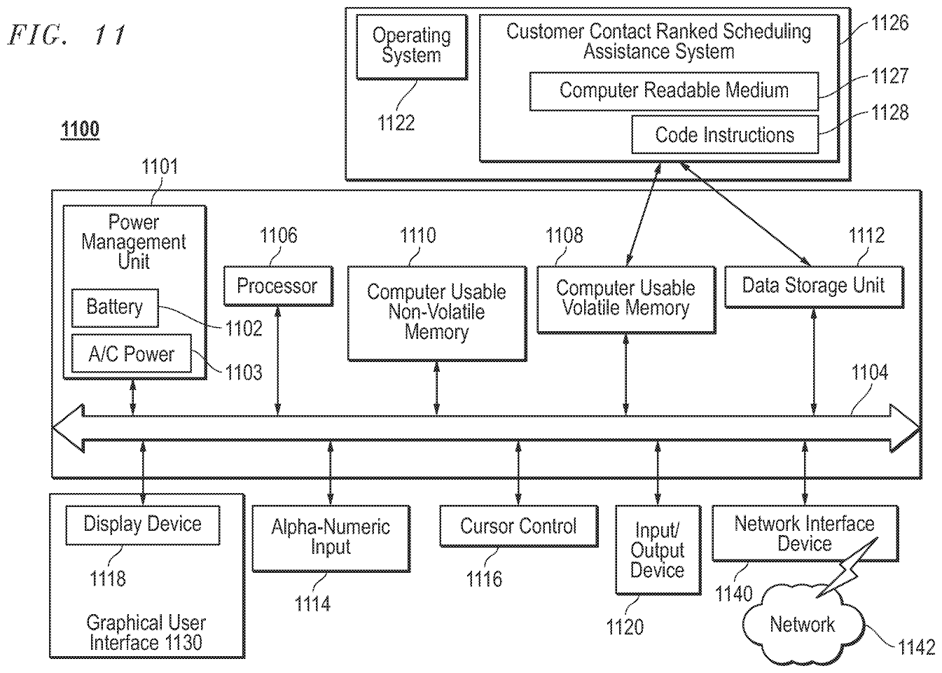

FIG. 11 is a block diagram illustrating a computing system 1100 executing code instructions 1128 of a customer contact ranked scheduling assistance system 1126 according to an embodiment of the present disclosure. All or portions of some embodiments described herein are composed of computer-readable and computer-executable instructions that reside, for example, in computer-usable/computer-readable storage media of a computing system. That is, FIG. 11 illustrates one example of a type of computer (computing system 1100) that can be used in accordance with or to implement various embodiments which are discussed herein. It is appreciated that computing system 1100 of FIG. 11 is only an example and that embodiments as described herein can operate on or in a number of different computing systems including, but not limited to, general purpose networked computing systems, embedded computing systems, routers, switches, server devices, client devices, various intermediate devices/nodes, stand-alone computing systems, media centers, handheld computing systems, multimedia devices, virtual machines (VMs), virtualization management servers, and the like. For example, computing systems may include servers, laptops, desktops, mobile smart phones, tablets, or other types of computer systems utilized by users according to embodiments herein.

System 1100 of FIG. 11 includes an address/data bus 1004 for communicating information, and a processor 1106 coupled with bus 1004 for processing information and instructions. System 1100 is also well suited to a multi-processor environment in which a plurality of processors are present. Conversely, system 1100 is also well suited to having a single processor such as, for example, processor 1106, which may be any of various types of microprocessors. System 1100 also includes data storage features such as a computer usable volatile memory 1108, e.g., random access memory (RAM), coupled with bus 1004 for storing information and instructions for processor 1106.

System 1100 also includes computer usable non-volatile memory 1110, (e.g., read only memory (ROM)), coupled with bus 1004 for storing static information and instructions for processor 1106. Additionally, the computer-readable medium may include a magneto-optical or optical medium, such as a disk or tapes or other storage device to store information received via carrier wave signals such as a signal communicated over a transmission medium. Furthermore, a computer readable medium may store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Also present in system 1100 is a data storage unit 1112 (e.g., a magnetic or optical disc and disc drive) coupled with bus 1004 for storing information and instructions. System 1100 also includes an alphanumeric input device 1114 including alphanumeric and function keys coupled with bus 1004 for communicating information and command selections to processor 1106. System 1100 also includes a cursor control device 1116 coupled with bus 1004 for communicating user input information and command selections to processor 1106. In one embodiment, system 1100 also includes a display device 1118 coupled with bus 1004 for displaying information.

Display device 1118 of FIG. 11 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 1116 allows the computer user to dynamically signal the movement of a visible symbol (cursor) on a display screen of display device 1118 and indicate user selections of selectable items displayed on display device 1118. Many implementations of cursor control device 1116 are known in the art including a trackball, mouse, touch pad, touch screen, joystick or special keys on alphanumeric input device 1114 capable of signaling movement of a given direction or manner of displacement.

Alternatively, it will be appreciated that a cursor can be directed and/or activated via input from alphanumeric input device 1114 using special keys and key sequence commands. System 1100 is also well suited to having a cursor directed by other means such as, for example, voice commands. In various embodiments, alphanumeric input device 1114, cursor control device 1116, and display device 1118, or any combination thereof (e.g., user interface selection devices), may collectively operate to provide a graphical user interface (GUI) 1130 under the direction of a processor (e.g., processor 1106). GUI 1130 allows user to interact with system 1100 through graphical representations presented on display device 1118 by interacting with alphanumeric input device 1114 and/or cursor control device 1116. System 1100 also includes an I/O device 1120 for coupling system 1100 with external entities.

A power management unit 1101 supplying power to the computing system 1100, via a battery 1102 or an alternating current (A/C) power adapter 1103 may supply power to one or more components of the computing system 1100, including the processor 1106, the network interface device 1140, and the GUI 1130.

In an embodiment, the computing system 1100 may include a network interface device 1140 that can provide connectivity to a network 1142, e.g., a wide area network (WAN), a local area network (LAN), wireless local area network (WLAN), a wireless personal area network (WPAN), a wireless wide area network (WWAN), or other networks. Connectivity may be via wired or wireless connection. The network interface device 1140 may operate in accordance with any wired or wireless data communication standards understood by those of skill. For example, to communicate with a wireless local area network, standards including IEEE 802.11 WLAN standards, IEEE 802.15 WPAN standards, WWAN such as 3GPP or 3GPP2, or similar wireless standards may be used. In some aspects of the present disclosure, one network interface device 1140 may operate two or more wireless links.

The network interface device 1140 may connect to any combination of macro-cellular wireless connections including 2G, 2.5G, 3G, 4G, 5G or the like from one or more service providers. Utilization of radiofrequency communication bands according to several example embodiments of the present disclosure may include bands used with the WLAN standards and WWAN carriers, which may operate in both licensed and unlicensed spectrums.

Referring still to FIG. 11, various other components are depicted for system 1100. Specifically, when present, an operating system 1122, customer contact ranked scheduling assistance system 1126, computer readable medium 1127, and code instructions 1128 are shown as typically residing in one or some combination of computer usable volatile memory 1108 (e.g., RAM), computer usable non-volatile memory 1110 (e.g., ROM), and data storage unit 1112. The customer contact ranked scheduling assistance system 1126 may, according to the present description, perform tasks related to generating a GUI display of a plurality of customer contacts for scheduling of future meetings, based on current criticality of such meetings. Further, the customer contact ranked scheduling assistance system may assist in the determination of such criticality and automate scheduling of such meetings.

The customer contact ranked scheduling assistance system 1126 may utilize a computer-readable medium 1127 in which one or more sets of code instructions 1128 such as software may be embedded. The code instructions 1128 may embody one or more of the methods or logic as described herein. For example, instructions relating to the customer contact ranked scheduling assistance system 1126, software algorithms, processes, and/or methods may be stored here. As explained, some or all of the customer contact ranked scheduling assistance system 1126 may be executed locally or remotely. In an embodiment, the customer contact ranked scheduling assistance system 1126 may communicate with the processor 1106, computer usable non-volatile memory 1110, network interface device 1140, GUI 1130 (e.g., including display device 1118, alpha-numeric input 1114, and cursor control 1116) and input/output device 1120 via bus 1004, and several forms of communication may be used, including ACPI, SMBus, a 24 MHZ BFSK-coded transmission channel, or shared memory. Driver software, firmware, controllers and the like may communicate with applications on the computing system, and various hardware systems.

Code instructions 1128 may include a customer contact ranked scheduling assistance system 1126, application software, BIOS software, or other software applications or drivers detectable by processor 1106. The code instructions 1128 in an embodiment may reside completely, or at least partially, within the computer usable volatile memory 1108 or data storage unit 1112 during execution by the processor 1106. For example, code instructions 1128 may include a particular example of a customer contact ranked scheduling assistance system 1126, or other aspects or components. Various software modules comprising application code instructions 1128 may be coordinated by an operating system (OS) 1122, and/or via an application programming interface (API). An example operating system may include Windows®, Android®, and other OS types. Example APIs may include Win 32, Core Java API, or Android APIs. Application code instructions 1128 may also include any application processing drivers, or the like executing on computing system.

The architecture shown in FIG. 11 can be partially or fully virtualized. For example, computing system may be one or possibly many VMs executing on physical hardware and managed by a hypervisor, virtual machine monitor, or similar technology. Furthermore, in some embodiments, some or all of the components of computing system may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like.

Some or all of the system components and/or data structures may also be stored as contents (e.g., as executable or other machine-readable software instructions or structured data) on a computer-readable medium (e.g., as a hard disk, a memory, a computer network or cellular wireless network, or other data transmission medium, or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques.

The blocks of the flow diagrams of FIGS. 7-9 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another may communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A computing system executing code instructions of a customer contact ranked scheduling assistance system comprising:
a network interface device receiving from a customer relations management (CRM) platform, for a plurality of customers, a meeting deadline date, a meeting frequency value, and a revenue percentage value indicating that a percentage of a user's annual revenue is attributable to each of the plurality of customers;
a processor to execute code instructions of the customer contact ranked scheduling assistance system to:
determine, for the plurality of customers, a past due percentage value by dividing a number of days elapsed since the meeting deadline date by a number of days in the meeting frequency value;
determine, for each of the plurality of customers, a criticality ranking by weighting the past due percentage value with the revenue percentage value; and
a graphical user interface (GUI) displaying the plurality of customers, listed in order of the criticality ranking from highest to lowest for scheduling of upcoming meetings in order of criticality.

2. The computing system of claim 1, wherein the revenue percentage value weighting is adjusted according to a user-specified revenue weighting value to provide adjustability for an importance of the revenue percentage value in the criticality ranking.

3. The computing system of claim 1 further comprising:
the GUI displaying a list of a plurality of meetings scheduled with a subset of the plurality of customers on a user-specified date, and the revenue percentage value associated with each of the subset of the plurality of customers.

4. The computing system of claim 1 further comprising:
the processor to determine the user has a meeting scheduled in the future with a first of the plurality of customers; and
the processor to assign the first of the plurality of customers a criticality ranking of zero.

5. The computing system of claim 1 further comprising:
the processor to determine the meeting deadline date for a first of the plurality of customers has not yet occurred; and
the processor to assign the first of the plurality of customers a criticality ranking of zero indicating no criticality to schedule a meeting with the first of the plurality of customers.

6. The computing system of claim 1 further comprising:
the network interface device receiving from the CRM platform a list of a plurality dataset fieldnames associated with the plurality of customers that includes a fieldname identifying a dataset as containing the revenue percentage value;
the GUI displaying the list of dataset fieldnames; and
the processor receiving a user selection of the fieldname identifying a dataset as containing the revenue percentage value from the plurality of dataset fieldnames as a criticality factor for determining the criticality rankings.

7. The computing system of claim 1 further comprising:
the processor receiving a user instruction to schedule an upcoming meeting with one of the plurality of customers displayed by the GUI according to the criticality ranking, and automatically generating an email message to the one of the plurality of customers and an attached electronic calendar invitation; and
the network interface device transmitting the email message and the attached electronic calendar invitation to the one of the plurality of customers.

8. A method of ranking criticality of upcoming customer meetings comprising:
receiving, via a network interface device from a customer relations management (CRM) platform, for a plurality of customers, a meeting deadline date, a meeting frequency value, and a previous success rate indicating a percentage of previous meetings with each of the plurality of customers that resulted in revenue to a user;
determining, via a processor executing code instructions of a customer contact ranked scheduling assistance system, for the plurality of customers, a past due percentage value by dividing a number of days elapsed since the meeting deadline date by a number of days within the meeting frequency value;
determining, via the processor, for each of the plurality of customers, a criticality ranking by weighting the past due percentage value with the previous success rate; and
displaying, via a graphical user interface (GUI), the plurality of customers listed in order of the criticality ranking from highest to lowest for scheduling of upcoming meetings in order of criticality.

9. The method of claim 8, wherein the previous success rate weighting is adjusted according to a user-specified previous success rate weighting value to provide adjustability for an importance of the previous success rate weighting value in the criticality ranking.

10. The method of claim 8 further comprising:
displaying, via the GUI, a list of a plurality of meetings scheduled with a subset of the plurality of customers on a user-specified date, and the previous success rate associated with each of the subset of the plurality of customers.

11. The method of claim 8 further comprising:
receiving, via the network interface device, an indication that a first of the plurality of customers has accepted an invitation for an upcoming meeting on a user-specified date at a geographic location within a preset geographic zone;
generating a filtered and ranked queue, via the processor, by filtering the listed plurality of customers ranked according to the criticality factor to exclude a subset of the plurality of customers associated with locations outside the preset geographic zone; and
prompting the user to schedule a meeting with a second of the plurality of customers included in the filtered and ranked listed plurality of customers ranked according to the criticality ranking on the user-specified date.

12. The method of claim 8 further comprising:
receiving from the CRM platform, via the network interface device, a plurality of dataset fieldnames associated with the plurality of customers that includes a fieldname identifying a dataset as containing the previous success rate;
displaying, via the GUI, the plurality of dataset fieldnames; and
receiving a user selection of the dataset fieldname identifying the dataset containing the previous success rate from the plurality of dataset fieldnames as a criticality factor for determining the criticality ranking.

13. The method of claim 8 further comprising:
receiving, via the processor, a user instruction to schedule an upcoming meeting with one of the plurality of customers displayed by the GUI according to criticality ranking and automatically generating an email message to the one of the plurality of customers and an attached electronic calendar invitation; and
transmitting, via the network interface device, the email message to the one of the plurality of customers, and transmitting the attached electronic calendar invitation to the one of the plurality of customers and to a manager of the user.

14. The method of claim 8 further comprising:
determining, via the processor, that the user has a meeting scheduled in the future with a first of the plurality of customers; and
assigning the first of the plurality of customers a criticality ranking of zero indicating no criticality to schedule a meeting with the first of the plurality of customers.

15. A computing system executing code instructions of a customer contact ranked scheduling assistance system comprising:
a network interface device to receive from a customer relations management (CRM) platform, for a plurality of customers, a meeting deadline date, a meeting frequency value, a revenue percentage value, and a previous success rate;
a processor to execute code instructions of the customer contact ranked scheduling assistance system to:
determine a weighted revenue value by multiplying the revenue percentage value by a user-adjustable revenue weighting value;
determine a weighted previous success rate value by multiplying the previous success rate by a user-adjustable previous success rate weighting value;
determine, for the plurality of customers, a past due percentage value by dividing a number of days elapsed since the meeting deadline date by the meeting frequency value in days;
determine, for each of the plurality of customers, a weighted criticality ranking by weighting the past due percentage value with the weighted previous success rate and the weighted revenue percentage value;
a graphical user interface (GUI) to display the plurality of customers, listed in order of the weighted criticality ranking, from highest to lowest, for scheduling of upcoming meetings in order of criticality.

16. The computing system of claim 15 further comprising:
the GUI configured to display a list of a plurality of meetings scheduled with a subset of the plurality of customers on a user-specified date, and the revenue percentage value and previous success rate associated with each of the subset of the plurality of customers.

17. The computing system of claim 15 further comprising:
the network interface device to receive an indication that a first of the plurality of customers has accepted an invitation for an upcoming meeting on a user-specified date at a geographic location within a preset geographic zone;
the processor to generate a filtered and ranked queue by filtering the listed plurality of customers ranked according to the criticality factor for scheduling to exclude a subset of the plurality of customers associated with locations outside the preset geographic zone; and
the processor to prompt the user to schedule a meeting with a second of the plurality of customers included in the filtered and ranked listed plurality of customers ranked according to the criticality ranking on the user-specified date. having a highest criticality ranking and

18. The computing system of claim 17 further comprising:
the processor to prompt the user to schedule the meeting with the second of the plurality of customers included in the filtered and ranked listed plurality of customers having a highest criticality ranking according to the criticality ranking.

19. The computing system of claim 15 further comprising:
the processor to determine the user has a meeting scheduled in the future with a first of the plurality of customers; and
the processor to assign the first of the plurality of customers a criticality ranking of zero.

20. The computing system of claim 15 further comprising:
the GUI receiving a first user instruction setting the user-adjustable revenue weighting value and a second user instruction setting the user-adjustable previous success rate weighting value to adjust the respective relative importance in the weighted criticality ranking determination.
